(19) United States
(12) Patent Application Publication
(10) Pub. No.: US 2009/0172161 A1
(43) Pub. Date: Jul. 2, 2009

(54) System and methods for web-based interactive training content development, management, and distribution

(76) Inventor: Harvinder Singh, Raleigh, NC (US)

Correspondence Address: TRIANGLE PATENTS, P.L.L.C., P.O. BOX 28539, RALEIGH, NC, 27611-8539, US

(21) Appl. No.: 12/082,338

(22) Filed: Apr. 10, 2008

Related U.S. Application Data
(60) Provisional application No. 60/922,733, filed on Apr. 10, 2007.

(51) Int. Cl. G06F 15/16

(52) U.S. Cl. 709/225

(57) ABSTRACT

System and methods for integrated web-based interactive training content development, management and distribution including a network for remote access by users to a content distribution server having privilege-based user access to content in at least one delivery format, wherein the content is stored on a content server in a format-neutral manner and delivered to the users in dynamically recombinable formats based upon user profiles.

### BACKGROUND OF THE INVENTION

1. Field of the Invention

The present invention relates generally to training and knowledge collaboration systems and methods. Further, the present invention relates to web-based training content development, management and distribution, including digital rights management and knowledge-collaboration.

2. Description of the Prior Art

Prior art web-based training systems and portals are known. However, none provide integrated, web-based access for content authoring and personalized end user access without requiring author uploading and end user downloading of the content. Also, prior art systems do not functionally provide for collaborative authoring or end user access to content across a multiplicity of media and content types and combinations for the same content, i.e., prior art systems provide for format-specific content at authoring, which limits the end user presentation or access format to that same type.

### SUMMARY OF THE INVENTION

A first aspect of the present invention is to provide a system or platform for integrated web-based interactive training content development, management and distribution including a network for remote access by users to a content distribution server having privilege-based user access to content in at least one delivery format, wherein the content is stored on a content server in a format-neutral manner and delivered to the users in dynamically recombinable formats based upon user profiles.

A second aspect of the present invention is to provide the system set forth hereinabove wherein the system provides prescriptive content and adaptable content based upon user profiles and performance during content delivery sessions, the user profiles being persistently stored on the content distribution server, and regularly updated.

The present invention is further directed to a method for providing web-based interactive training content development, management and distribution including the steps of providing the system set forth hereinabove; registered users accessing the system based upon user privileges, such access including format-neutral content delivered in a format-specific mode based upon user profile; the system updating the user profile based upon user inputs and performance during content delivery sessions; and the user profiles being persistently stored on the content distribution server.

Thus, the present invention provides a completely integrated web-service training platform for format-neutral content subcomponents that are prescriptively and adaptively combined into format-specific training sessions delivered to a registered user having privileges and a corresponding user profile that is persistently stored and regularly updated to reflect system use and progress, as well as user-defined inputs.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIGS. 1-53, 59-73 provide schematic and/or flow diagrams relating to the present invention. FIGS. 54-58 show a screen shot or static display of a web interface and mobile device interface for users of the system.

### DETAILED DESCRIPTION

Generally, the present invention provides systems and methods for integrated web services platform for training. More particularly, the present invention provides a system or platform and corresponding methods for integrated web-based interactive training content development, management and distribution including a network for remote access by users to a content distribution server having privilege-based user access to content in at least one delivery format, wherein the content is stored on a content server in a format-neutral manner and delivered to the users in dynamically recombinable formats based upon user profiles. Preferably, the system provides prescriptive content and adaptable content based upon user profiles and performance during content delivery sessions, the user profiles being persistently stored on the content distribution server, and regularly updated.

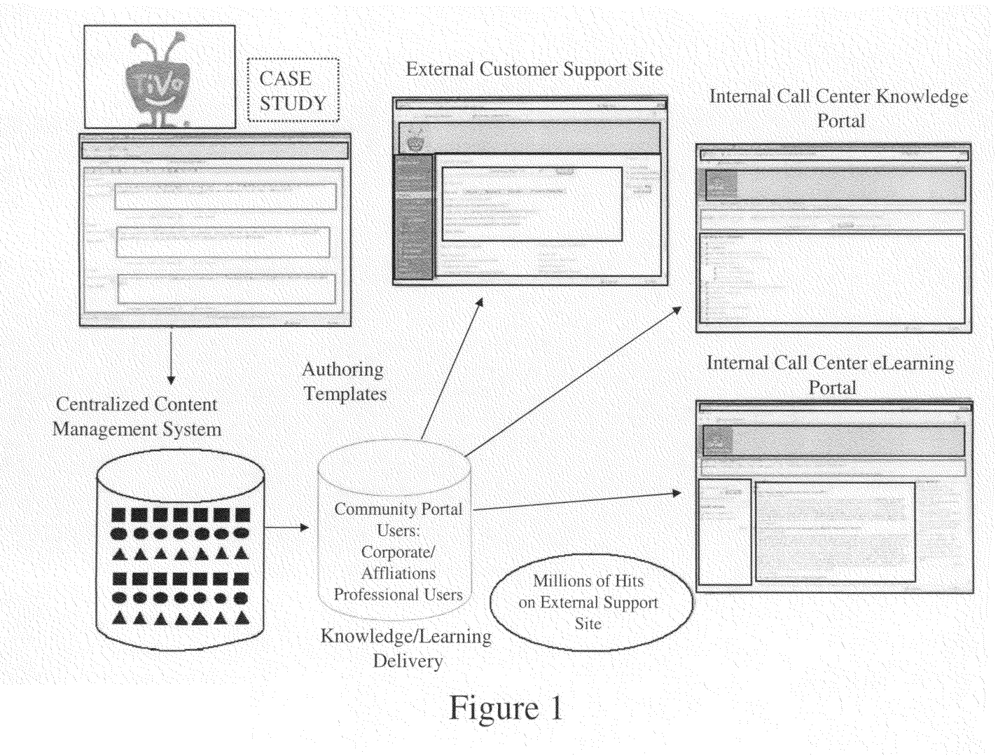

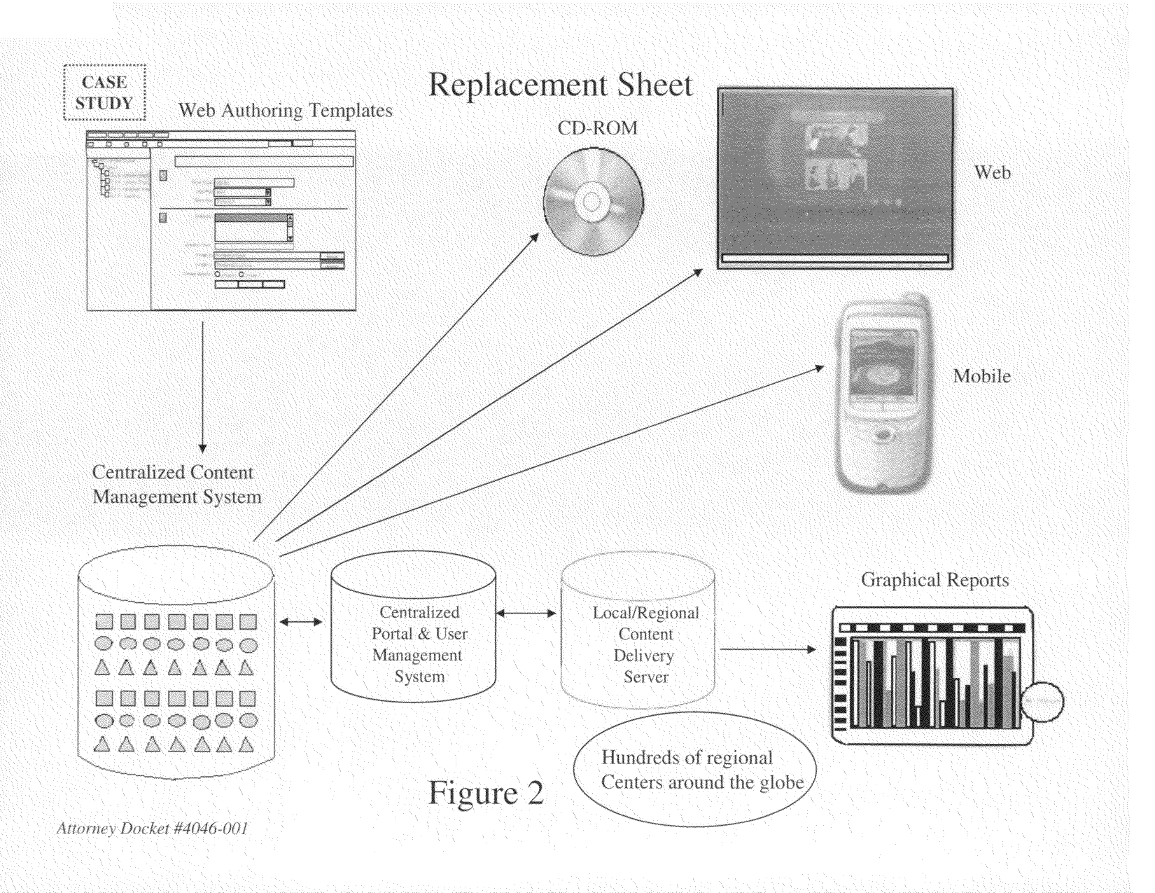

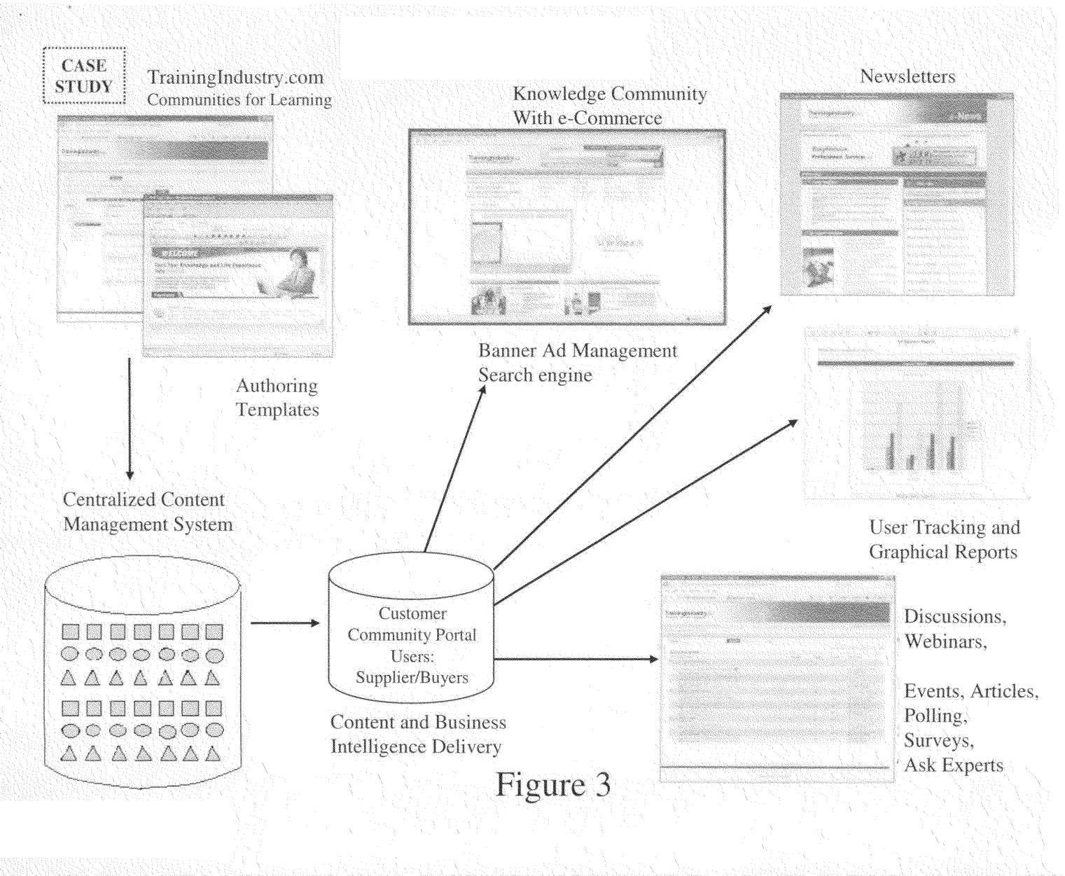

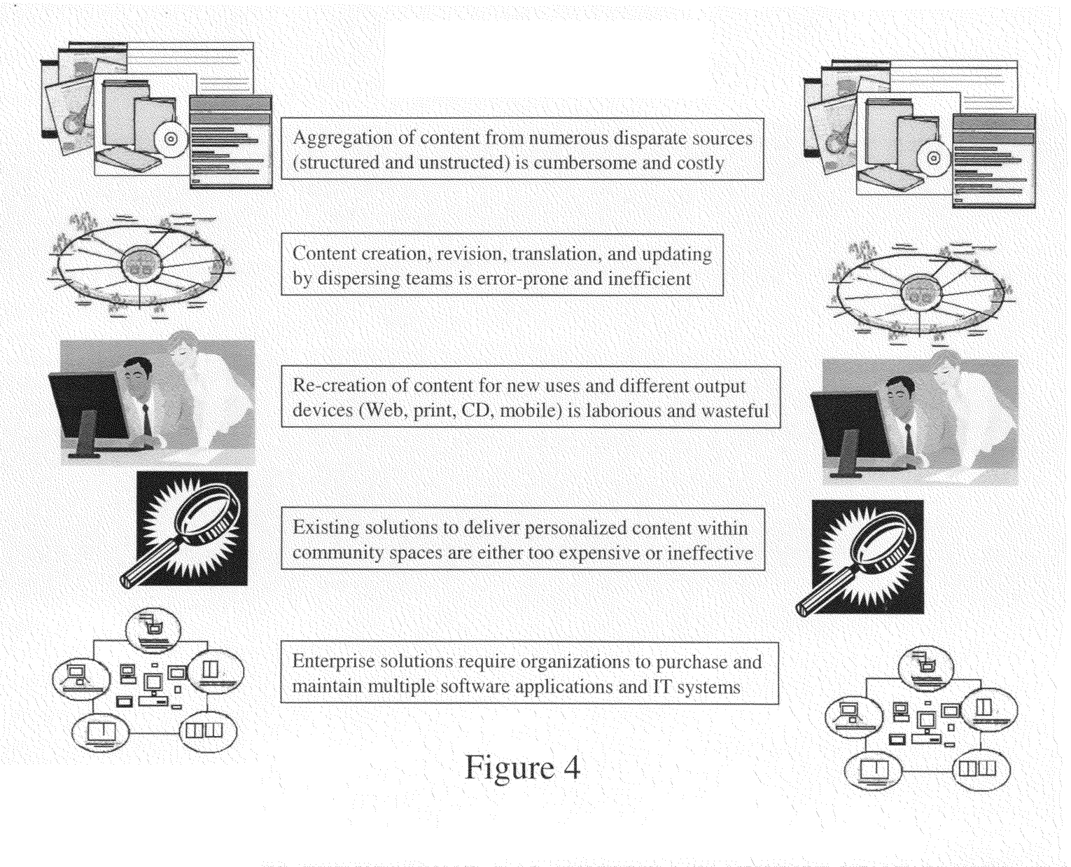

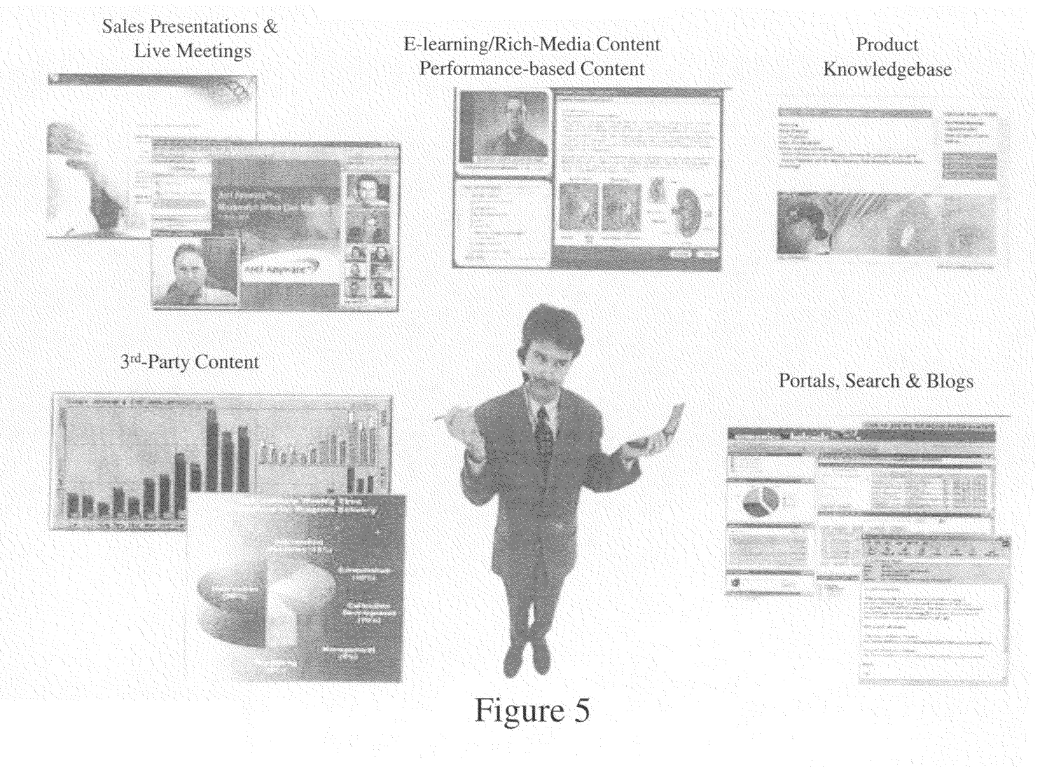

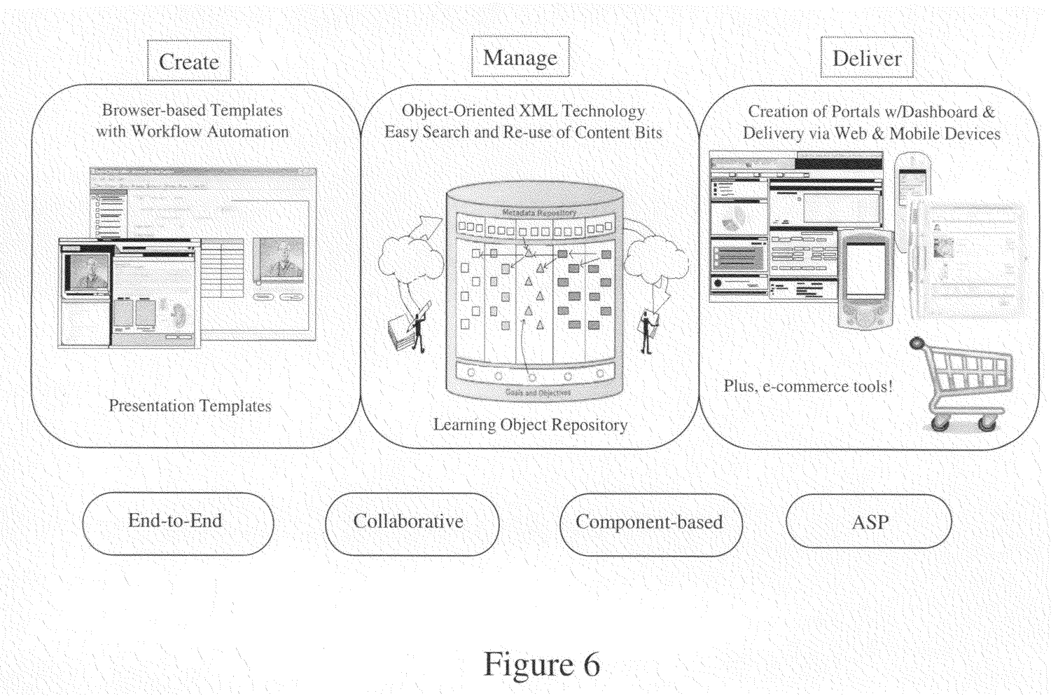

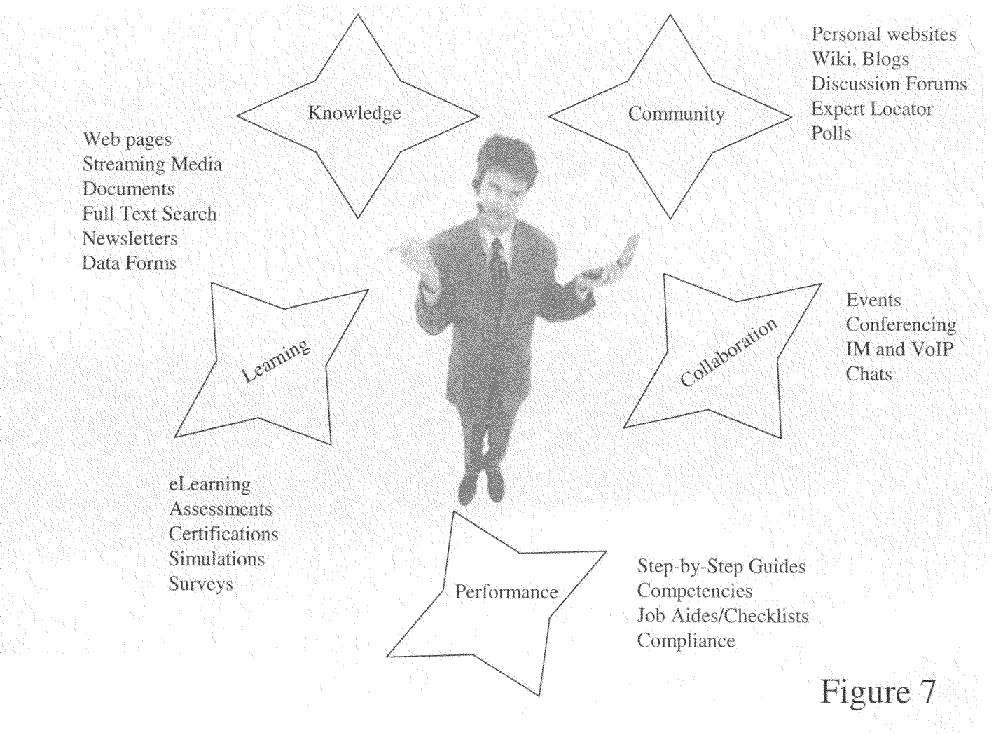

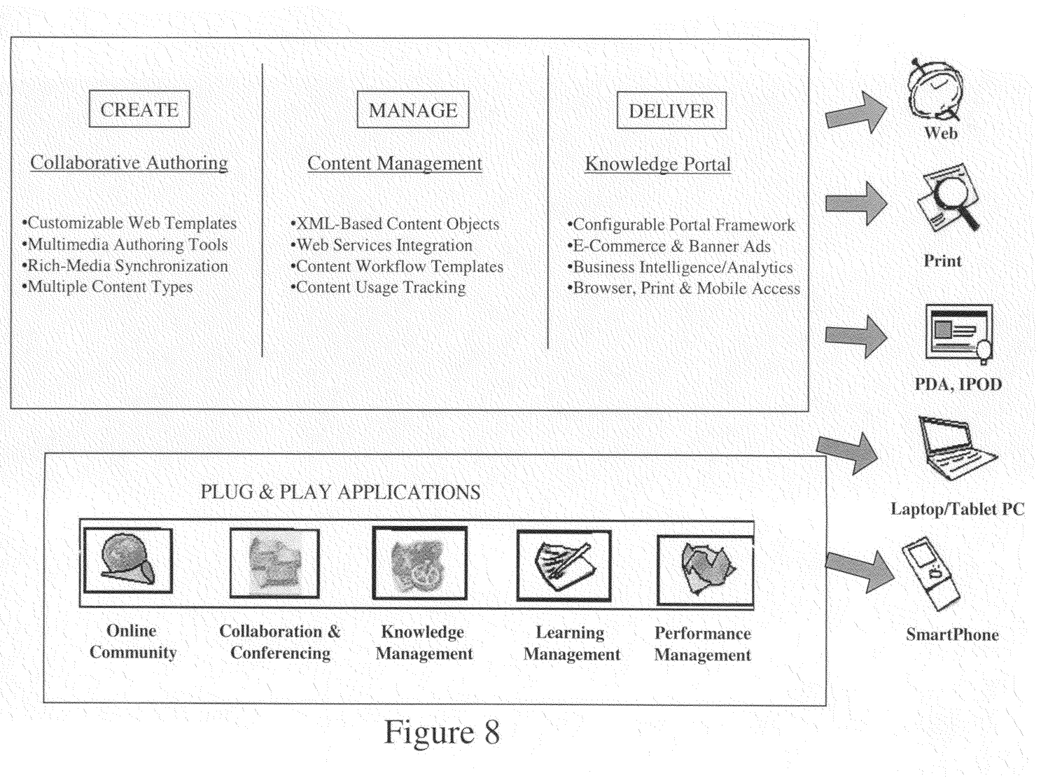

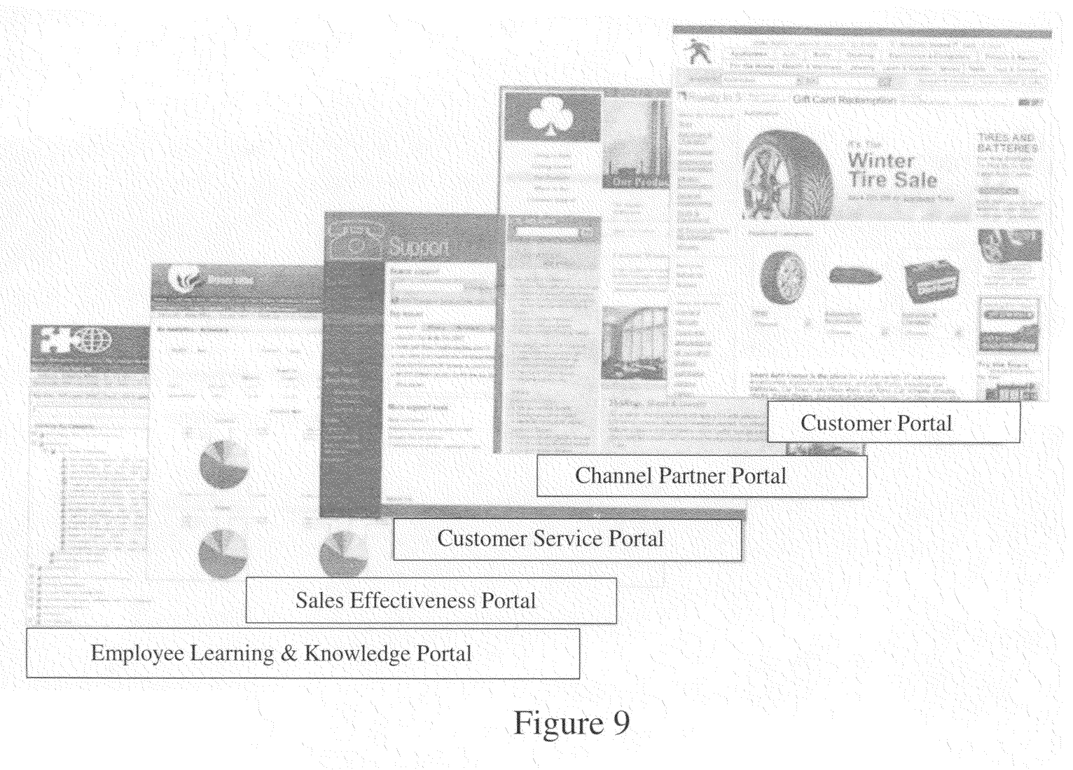

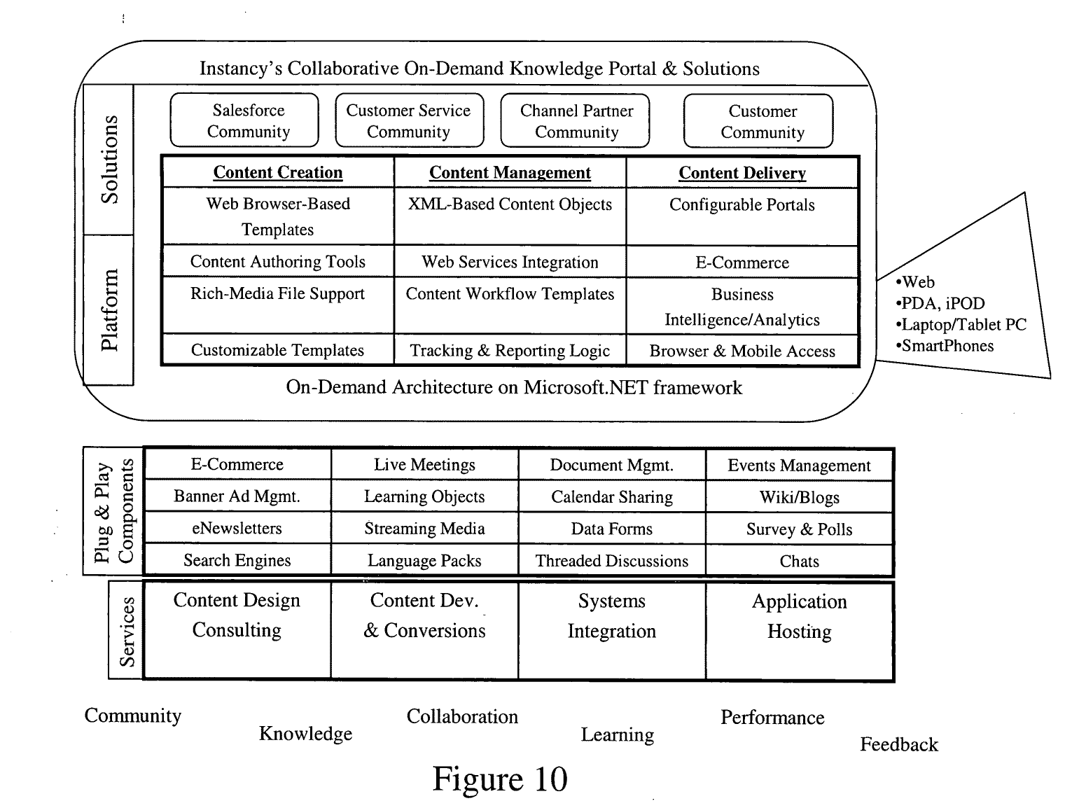

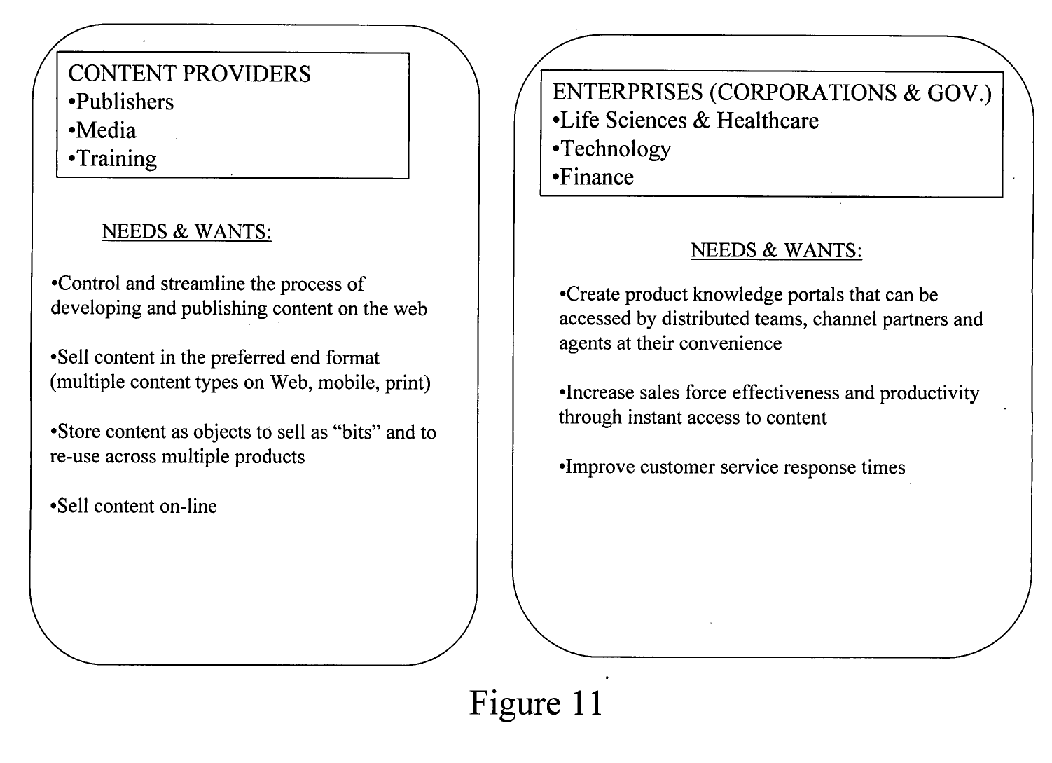

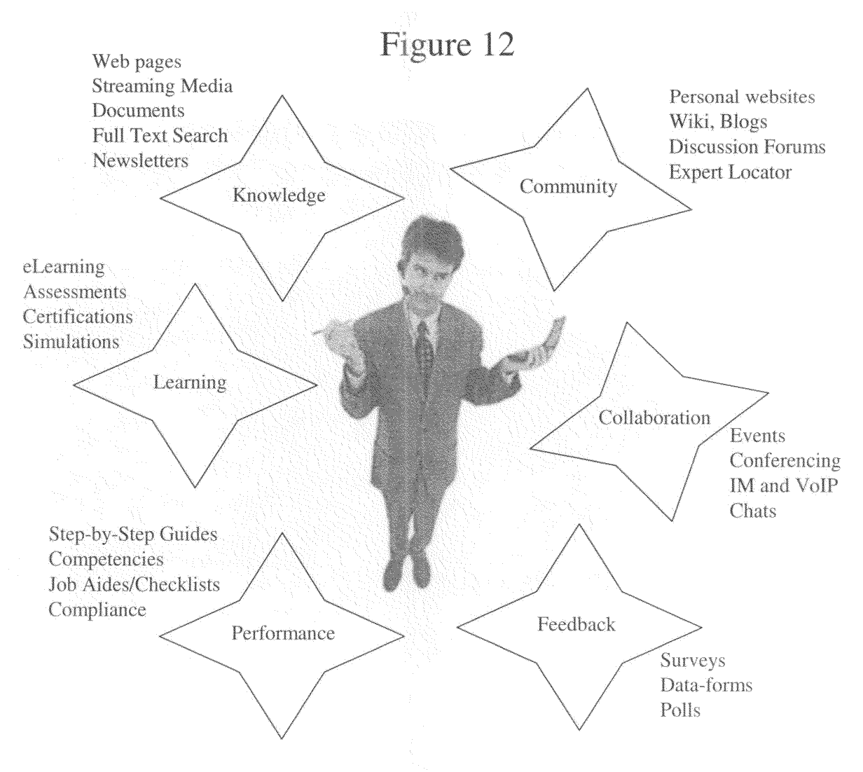

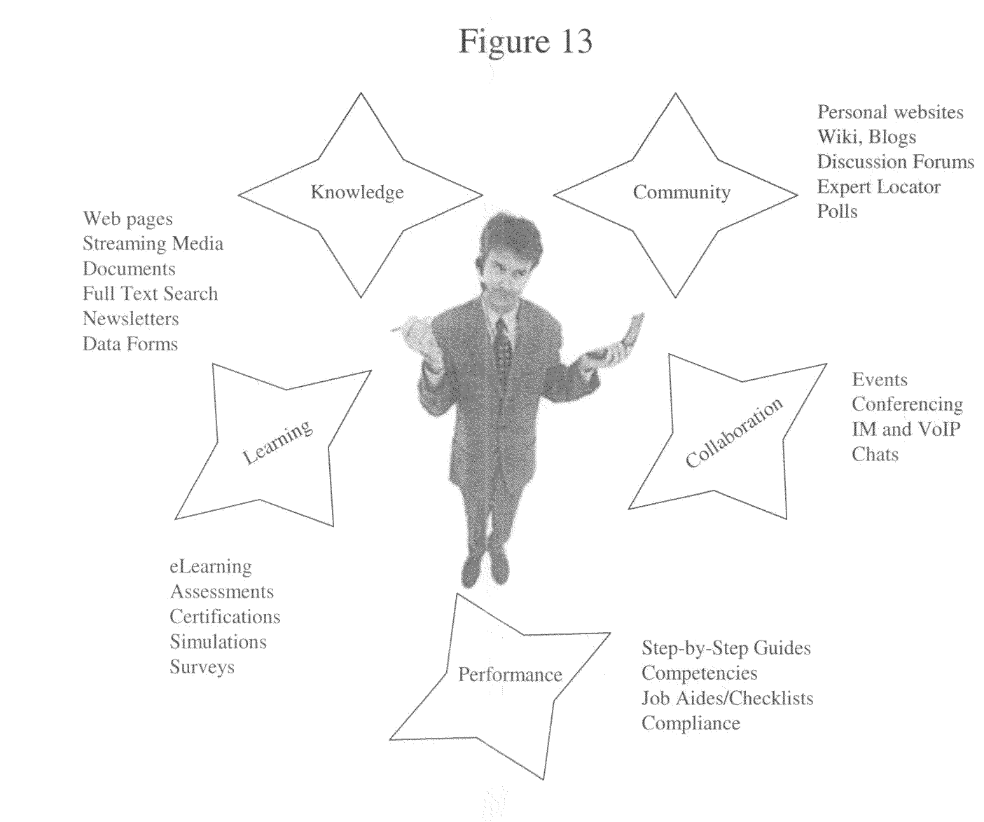

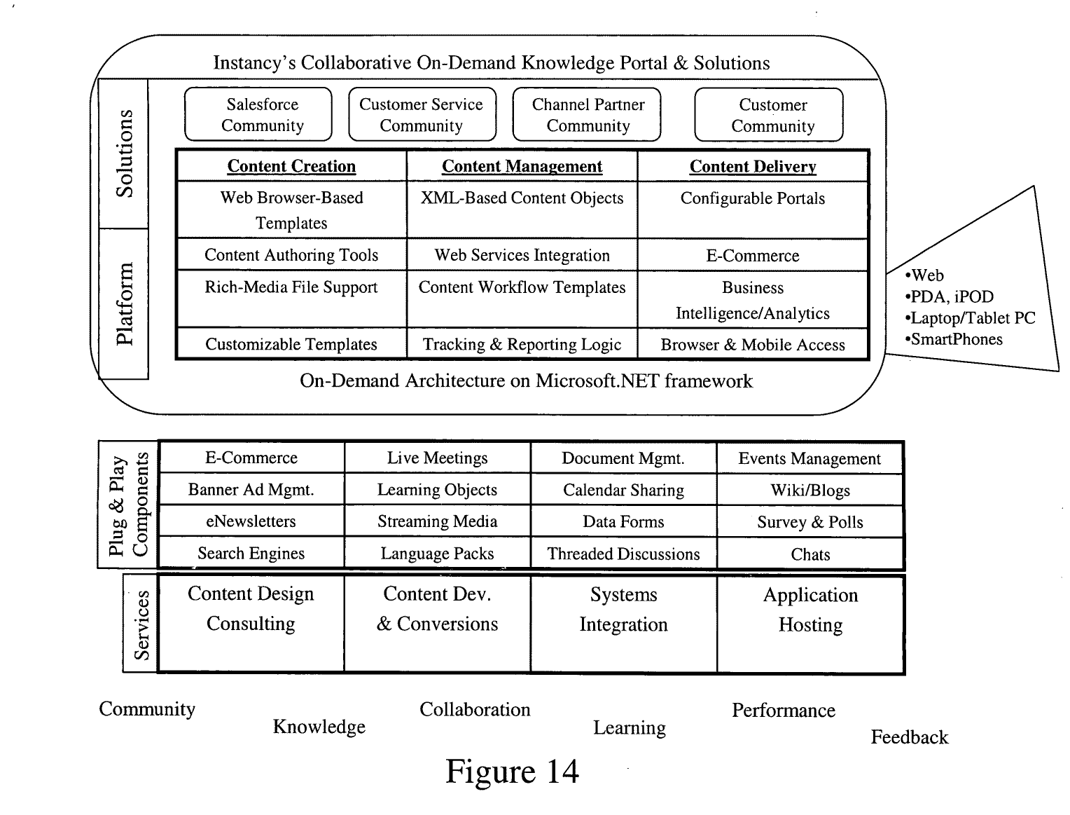

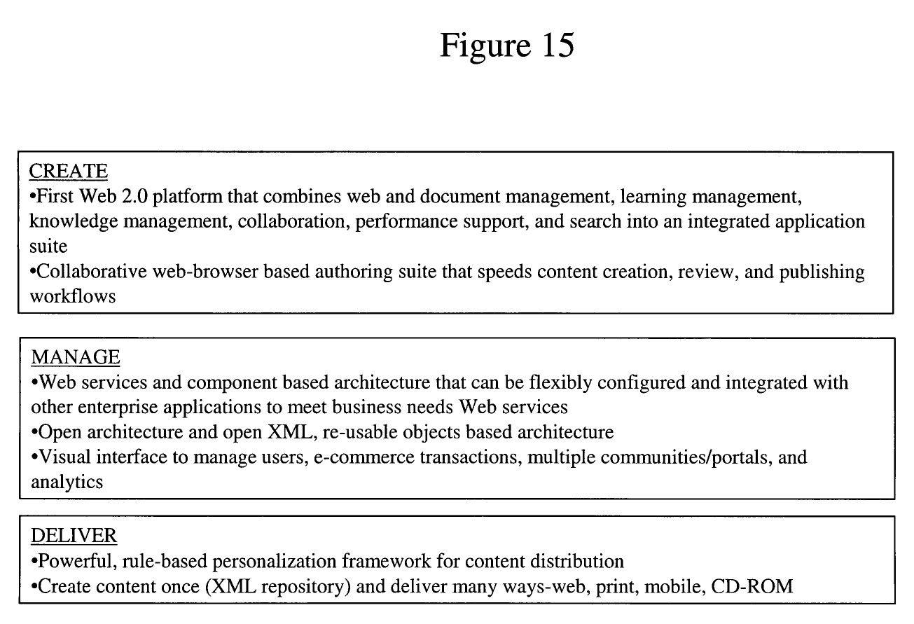

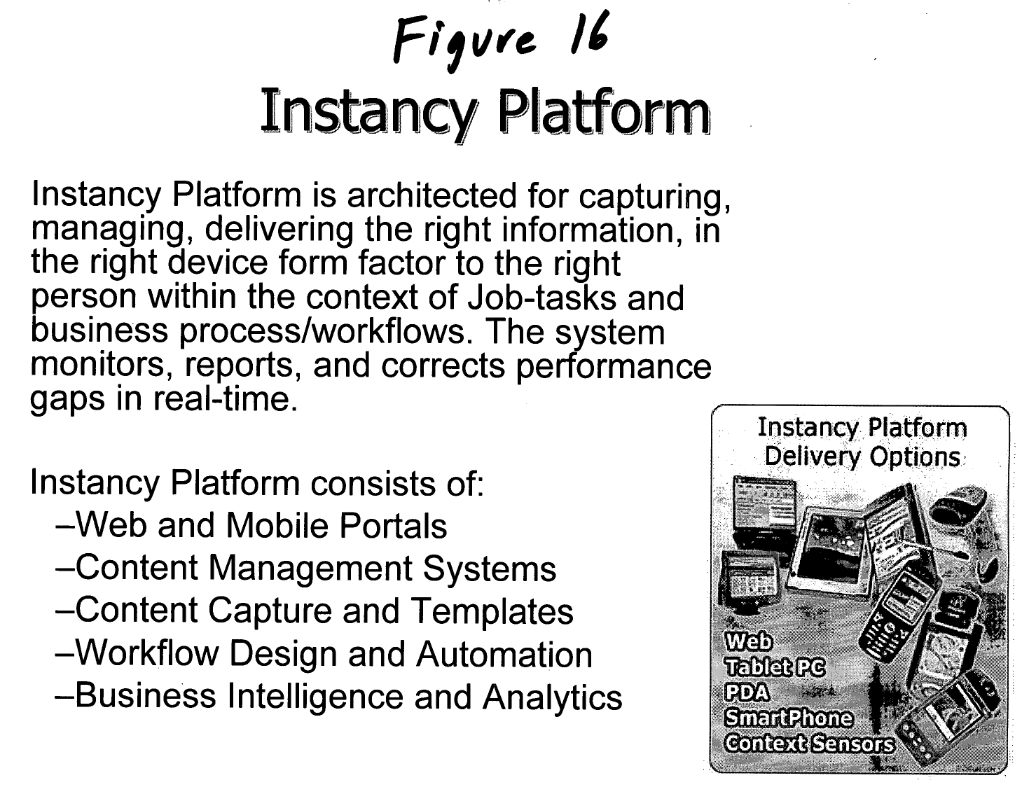

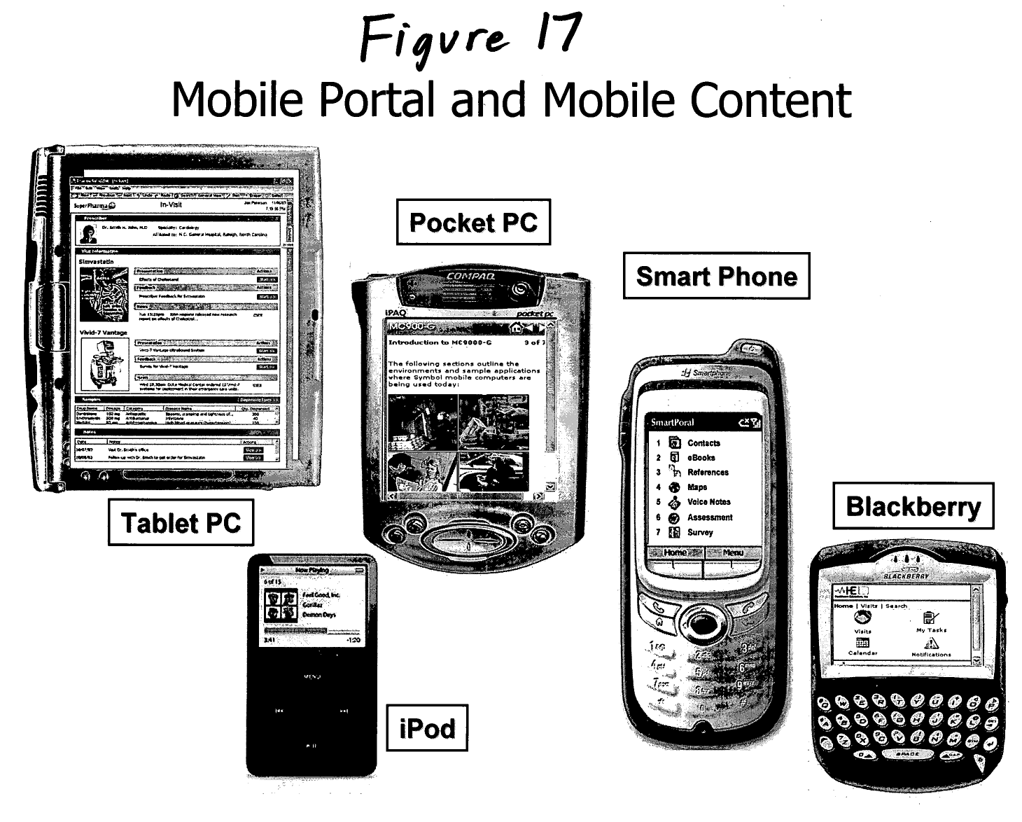

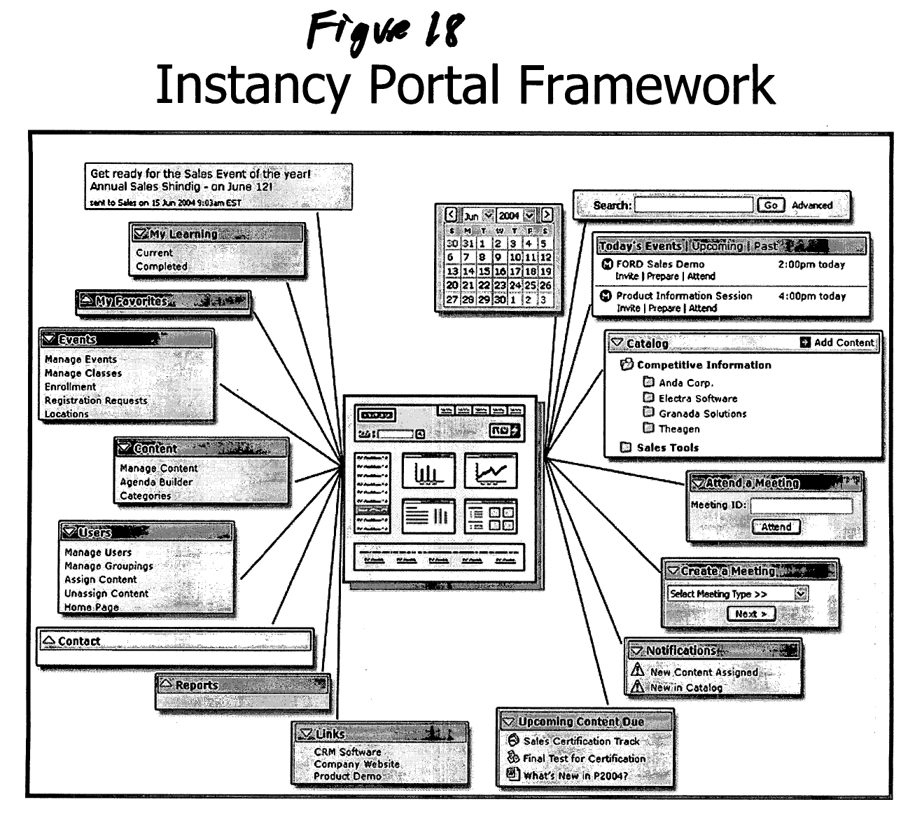

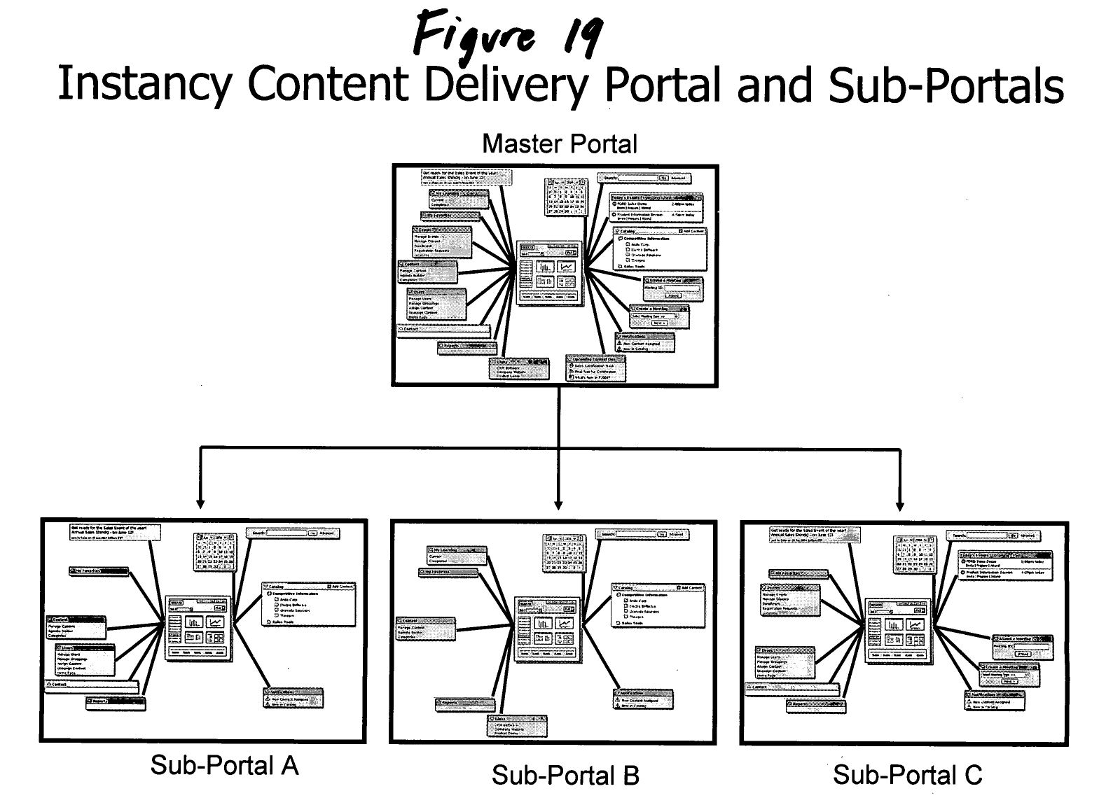

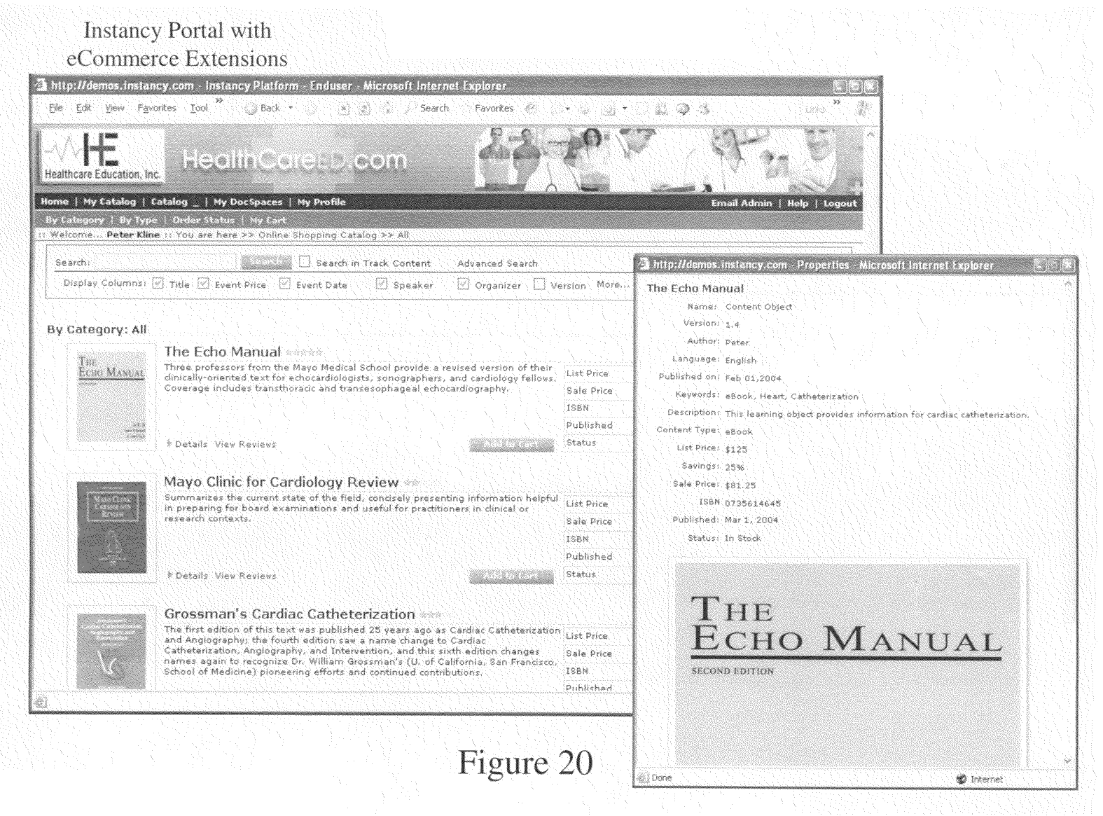

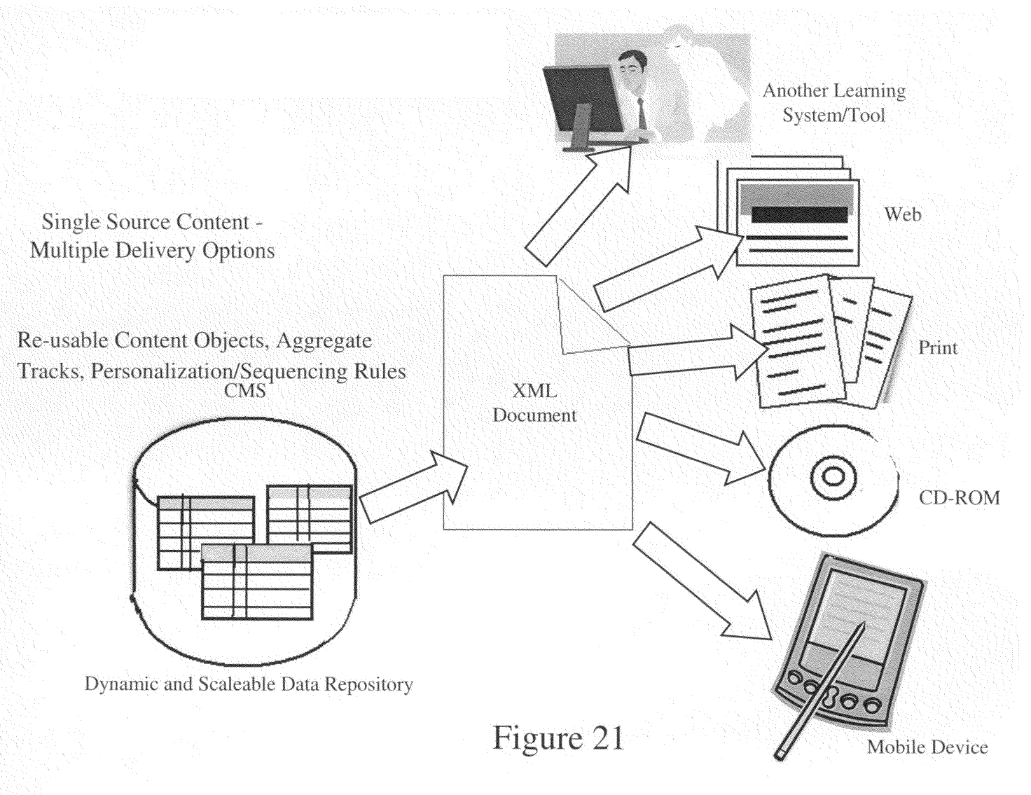

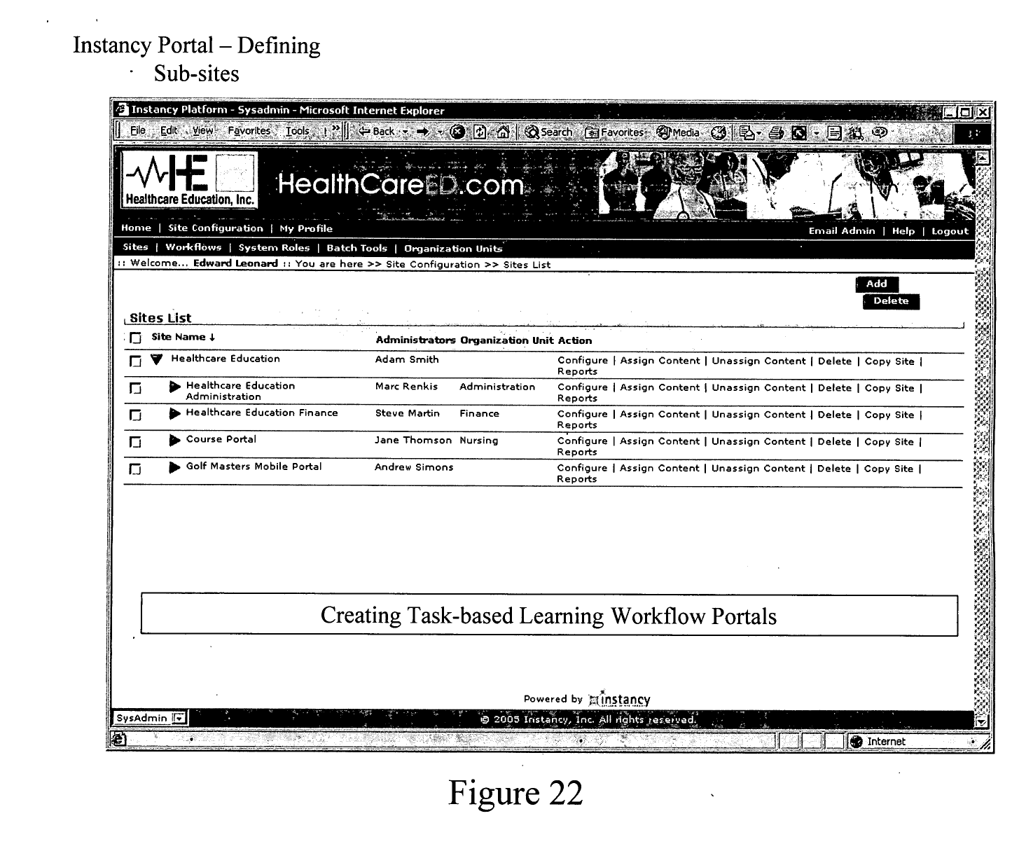

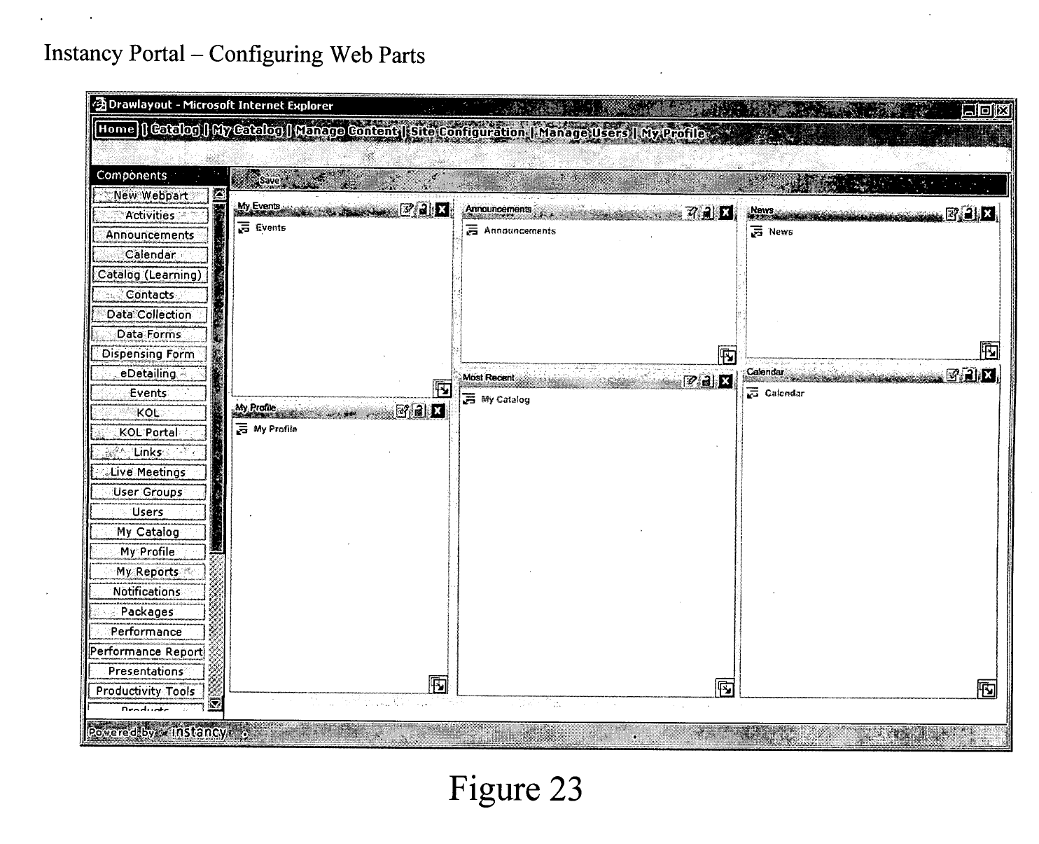

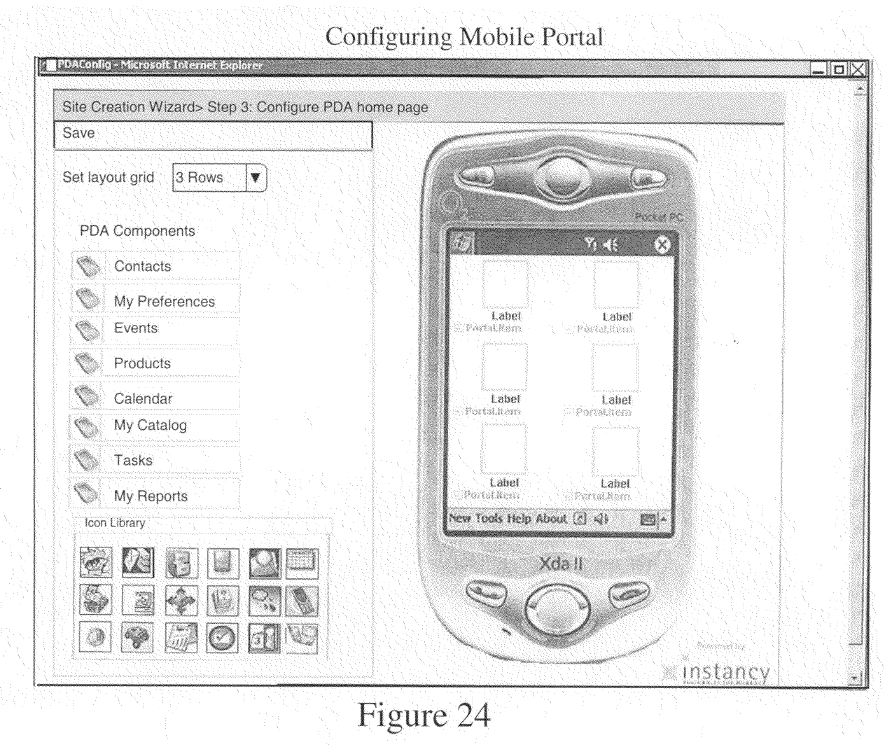

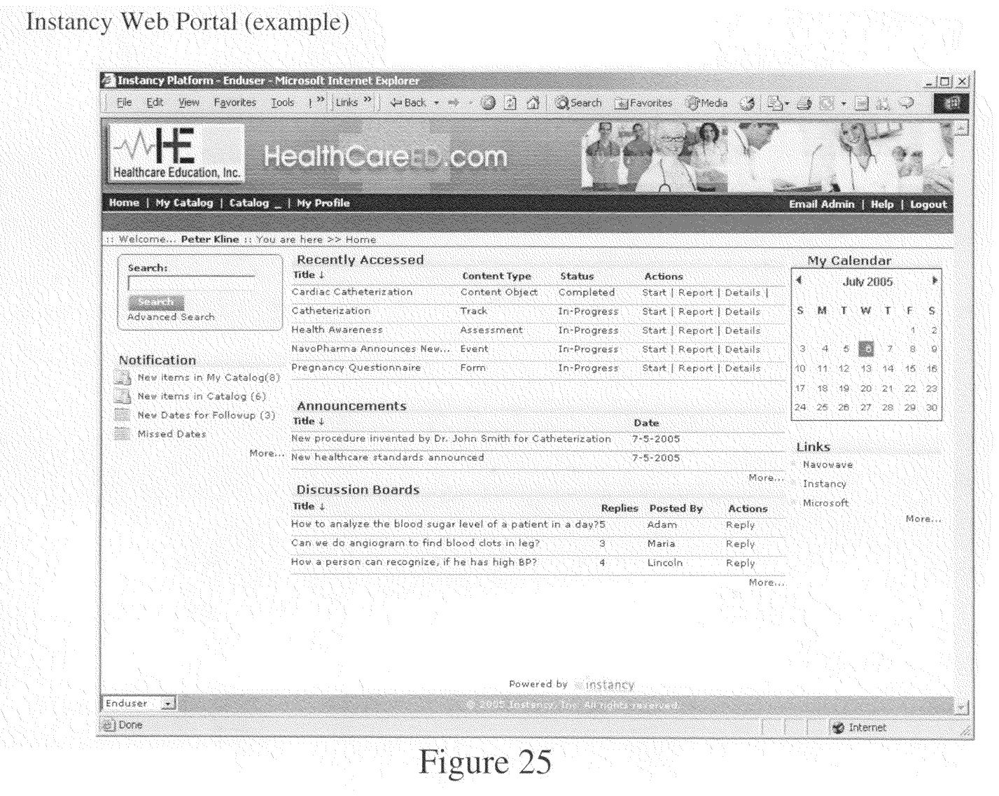

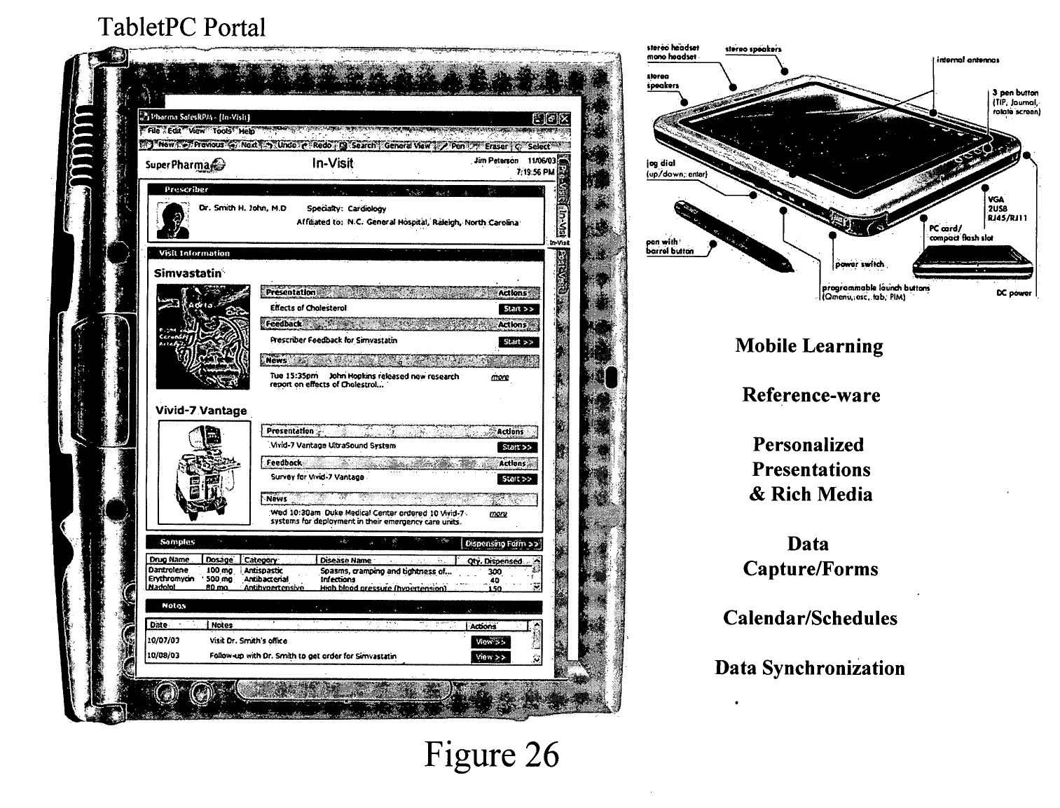

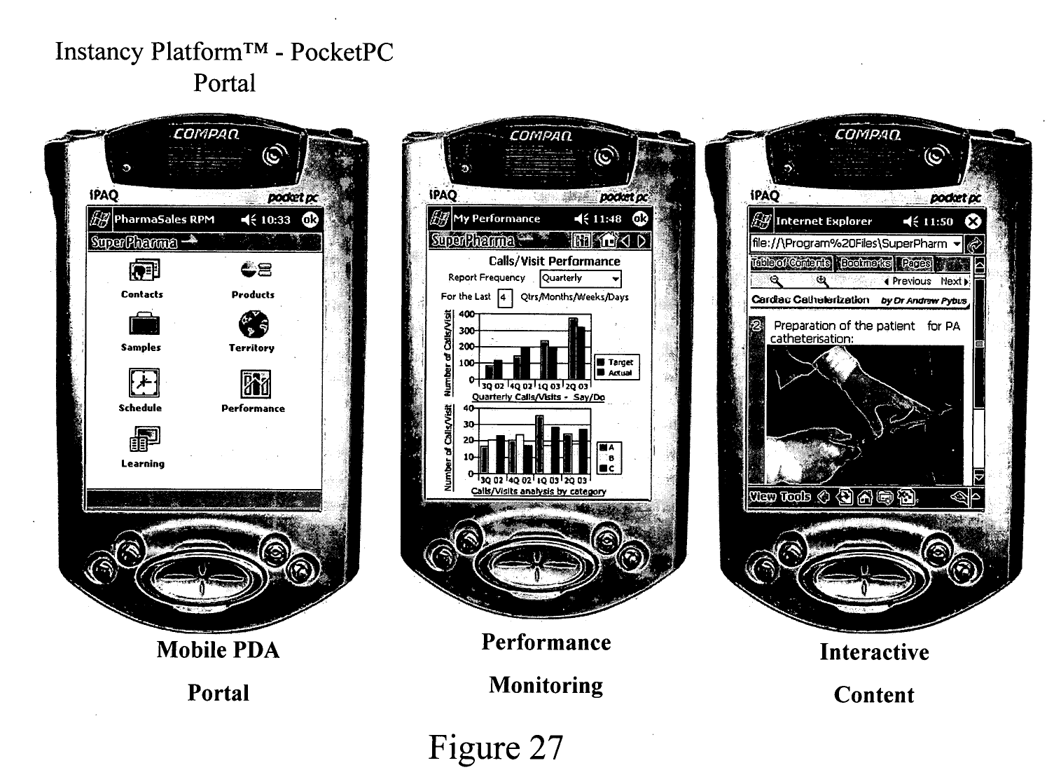

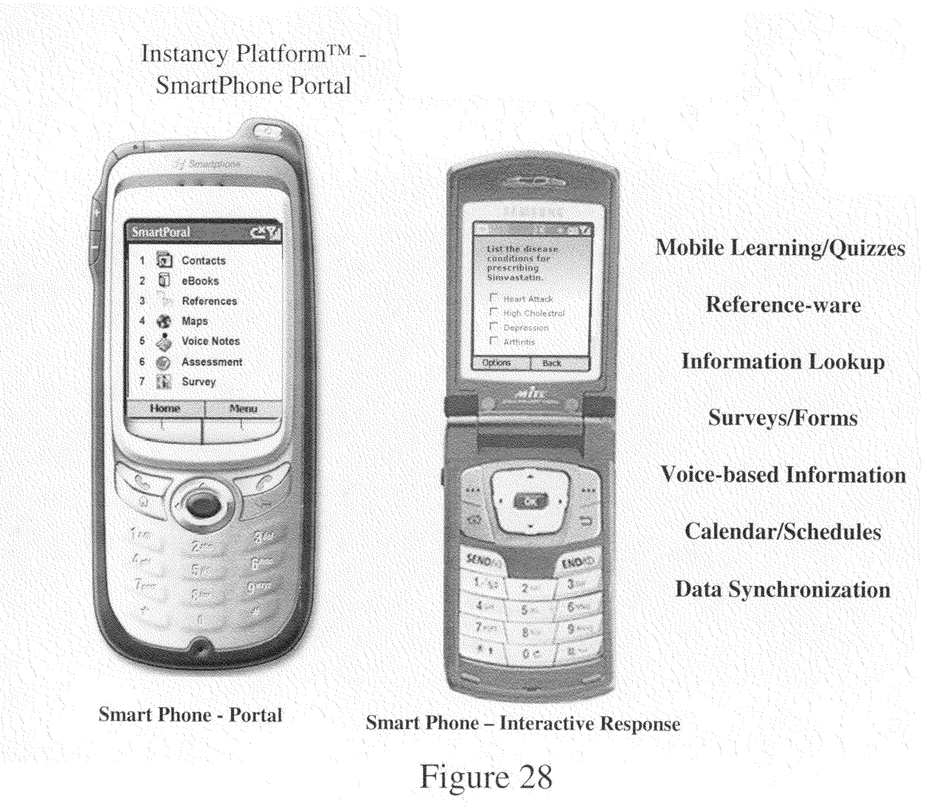

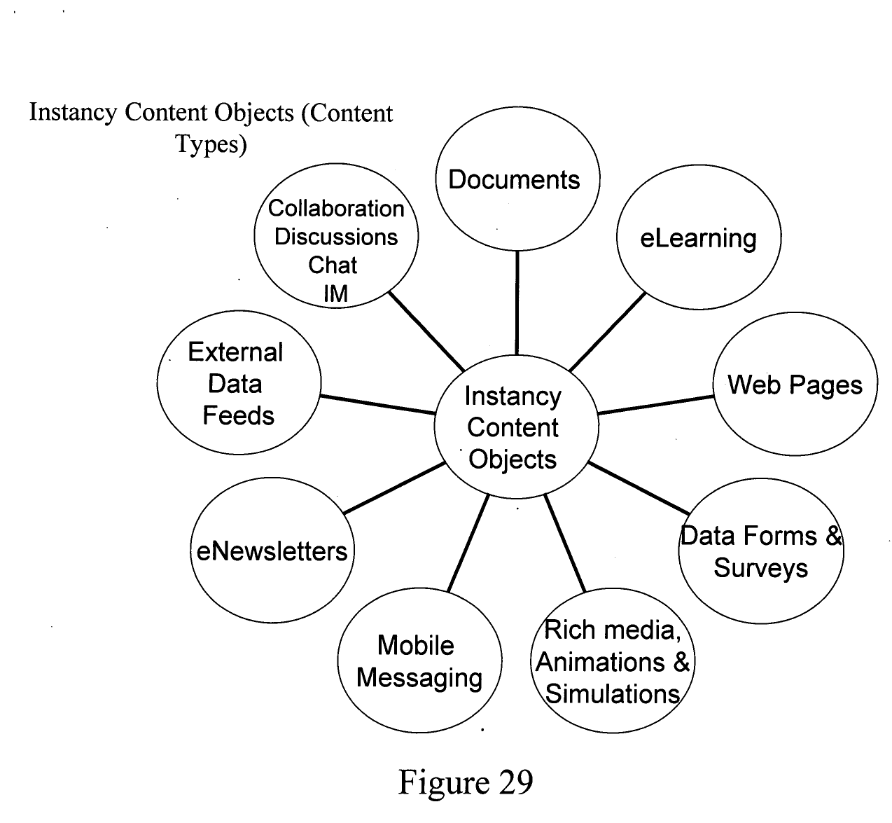

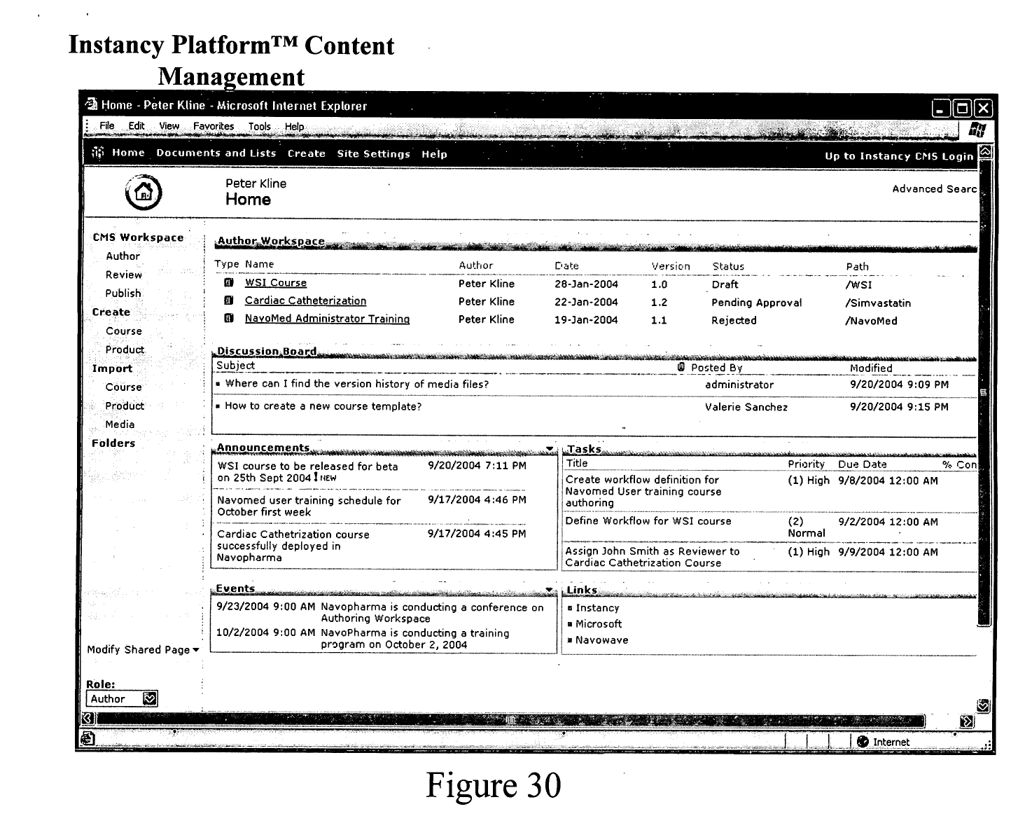

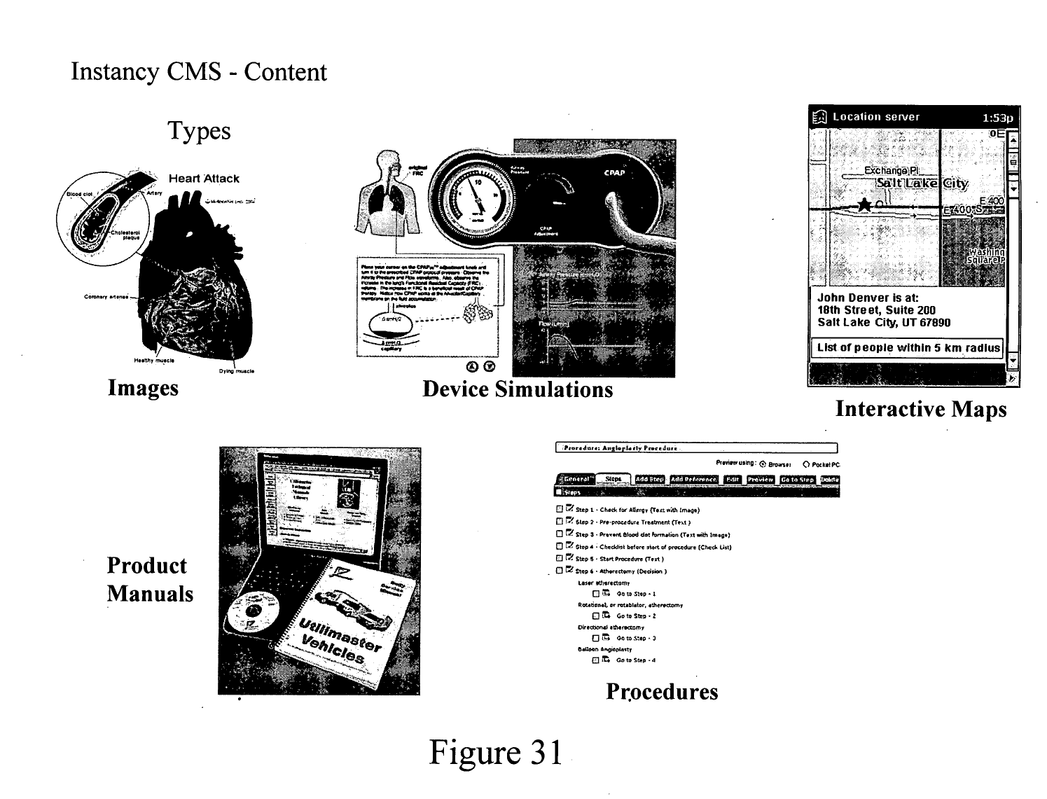

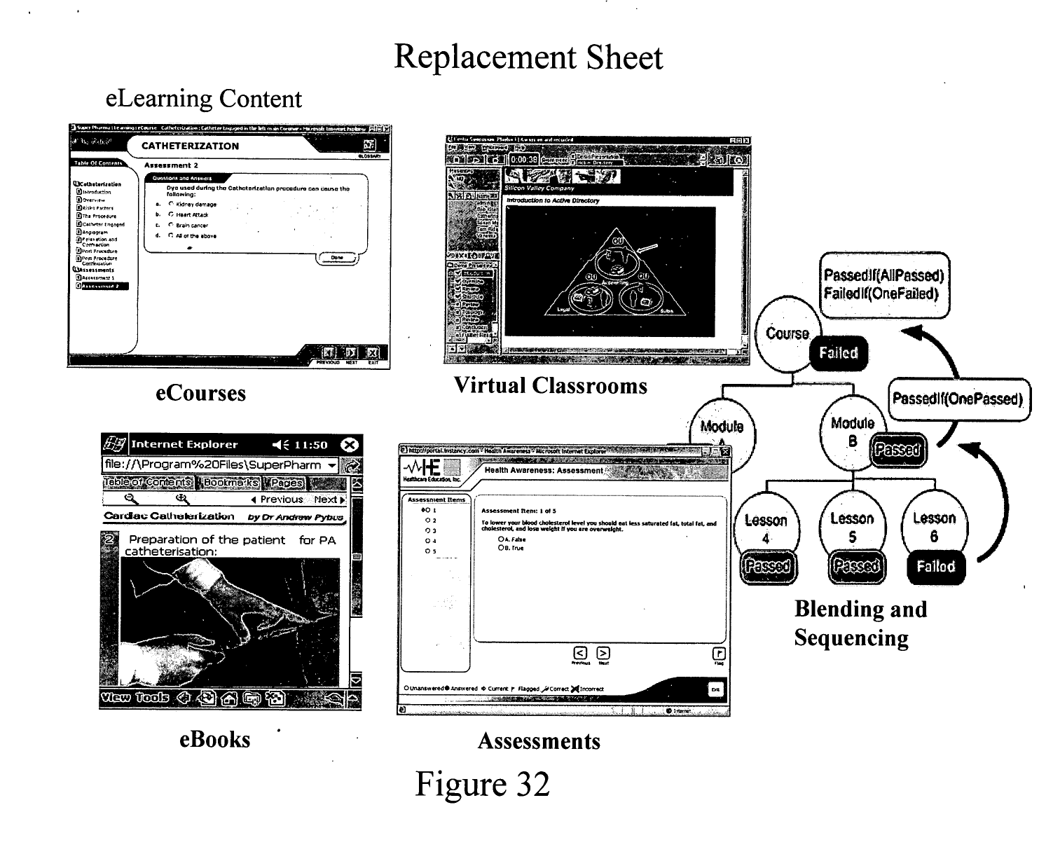

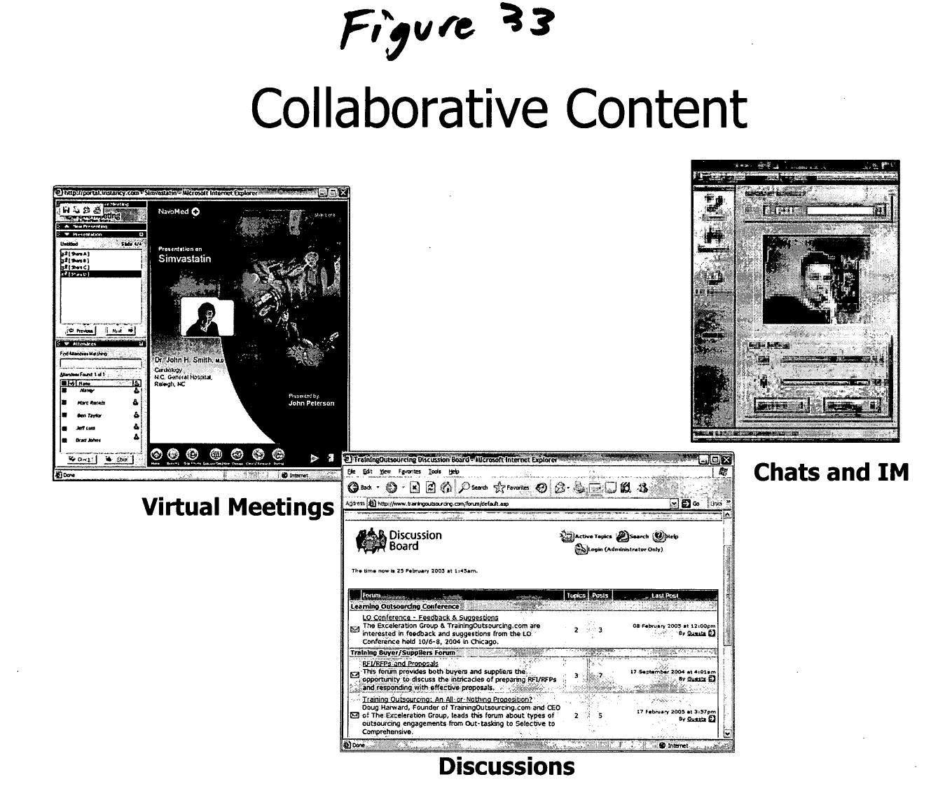

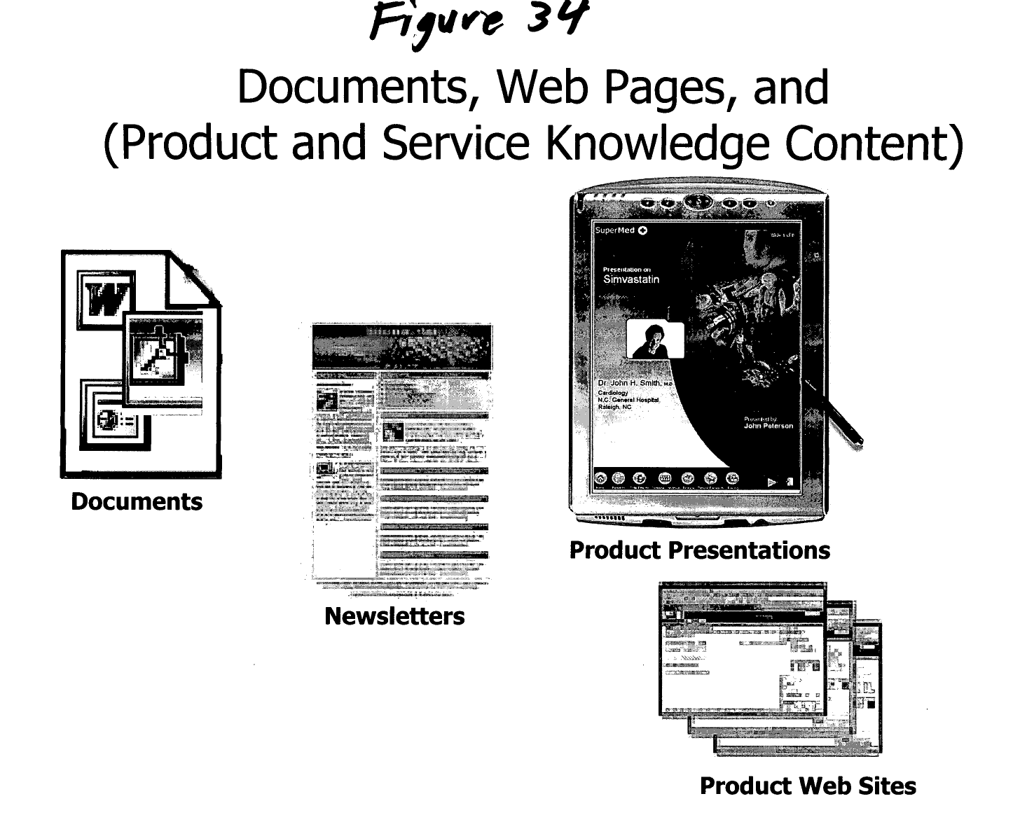

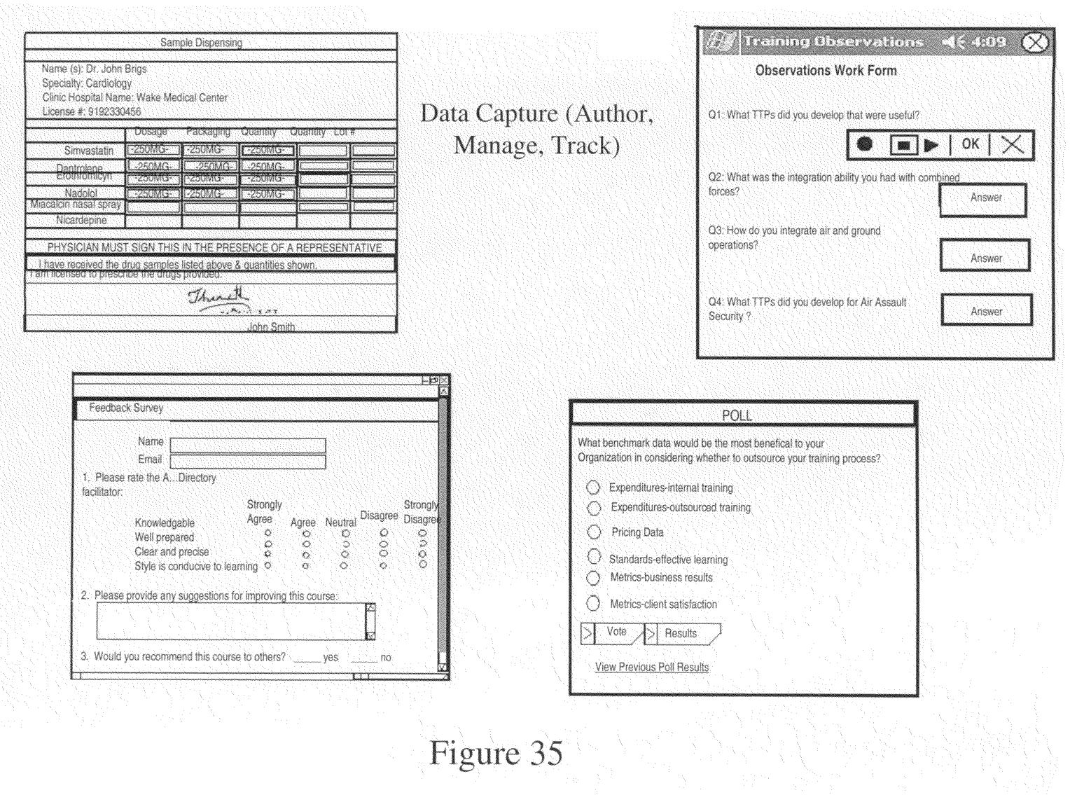

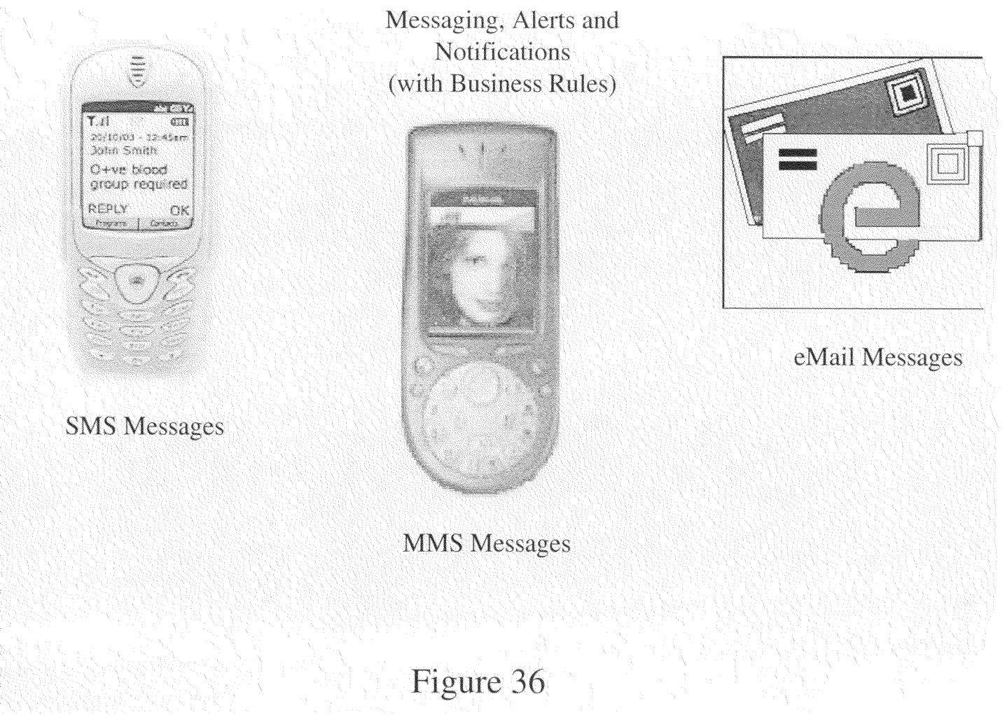

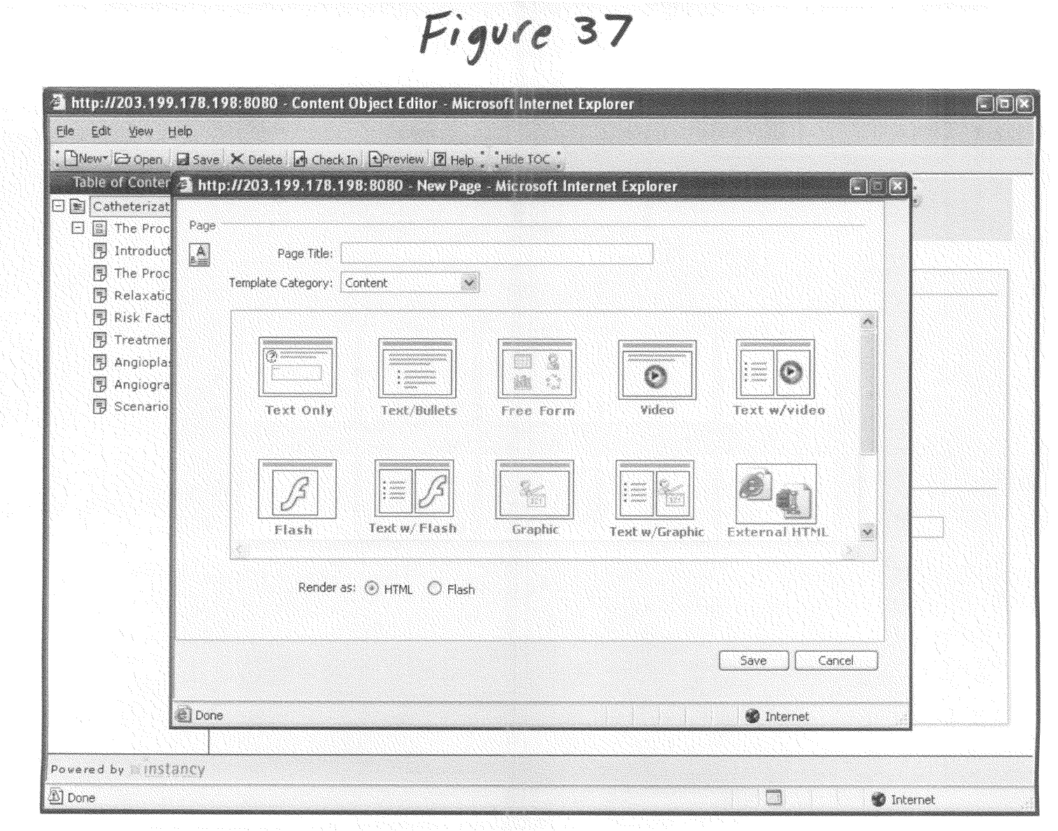

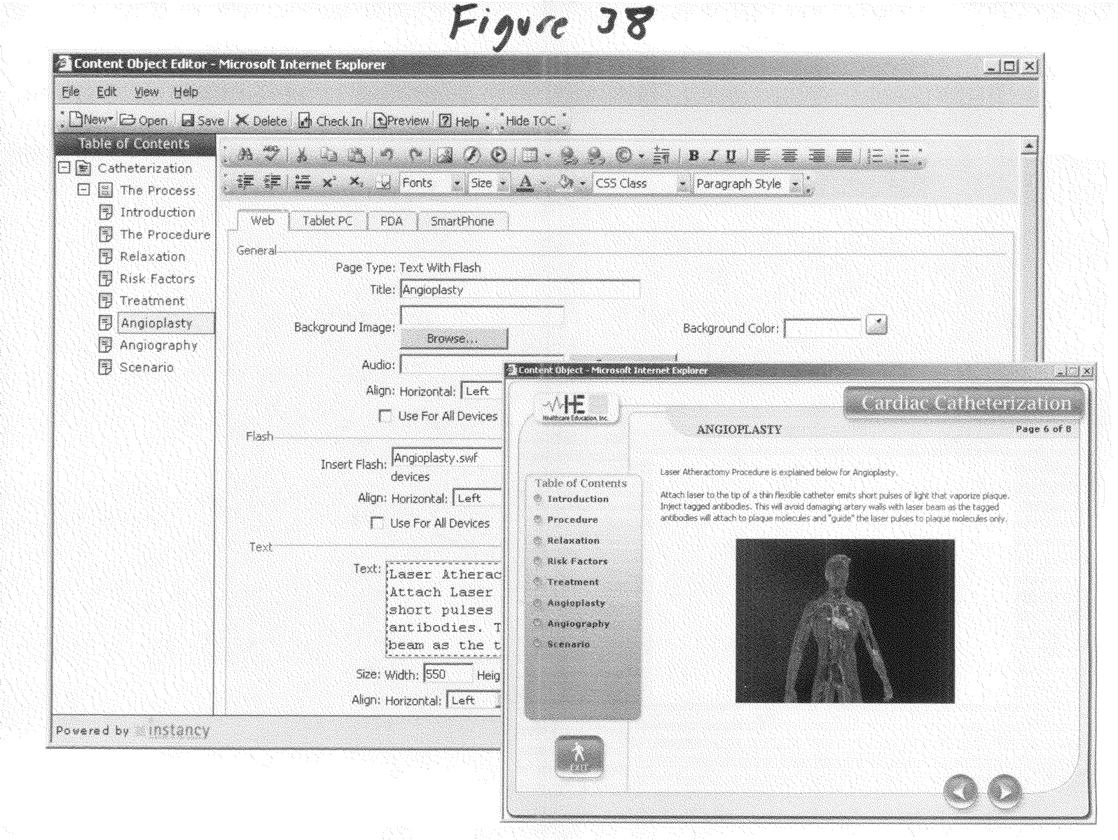

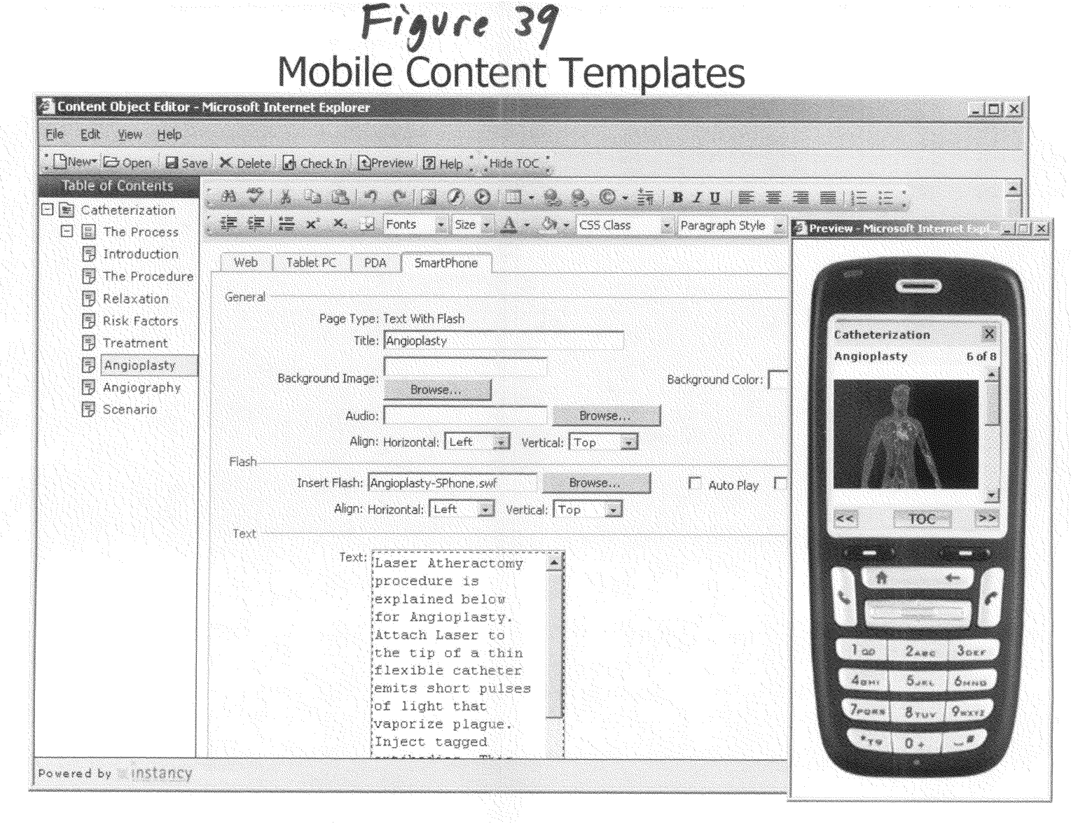

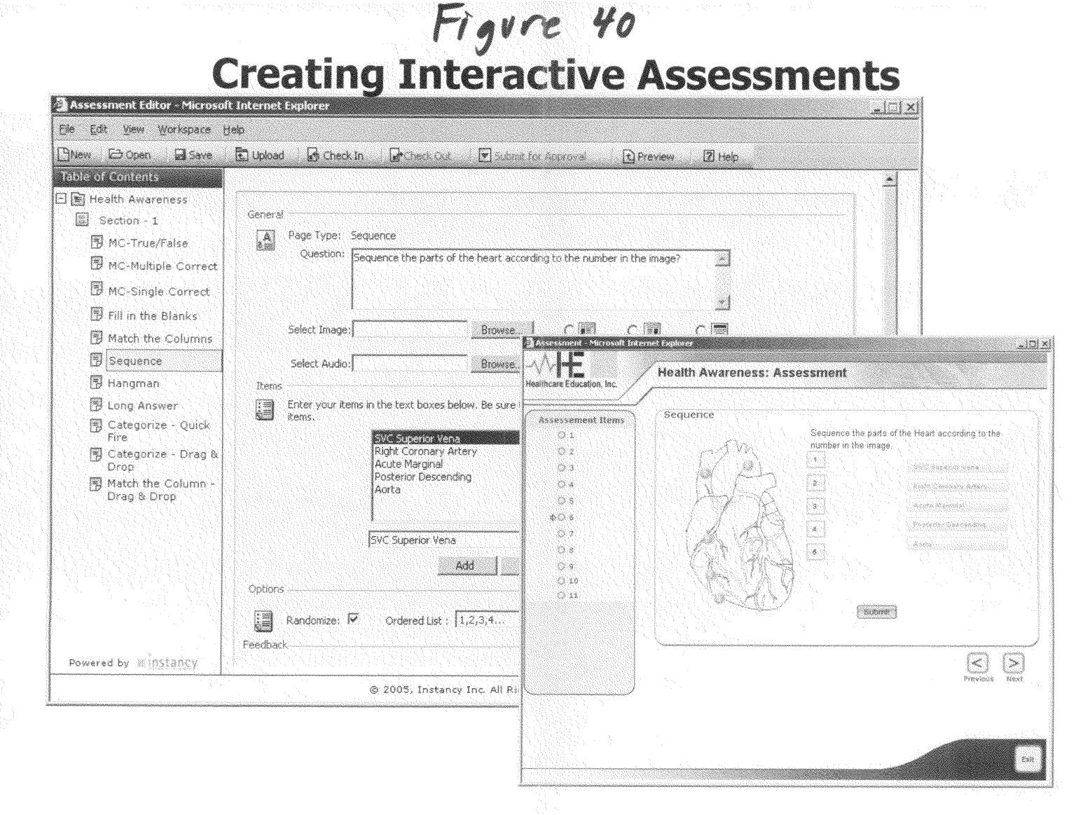

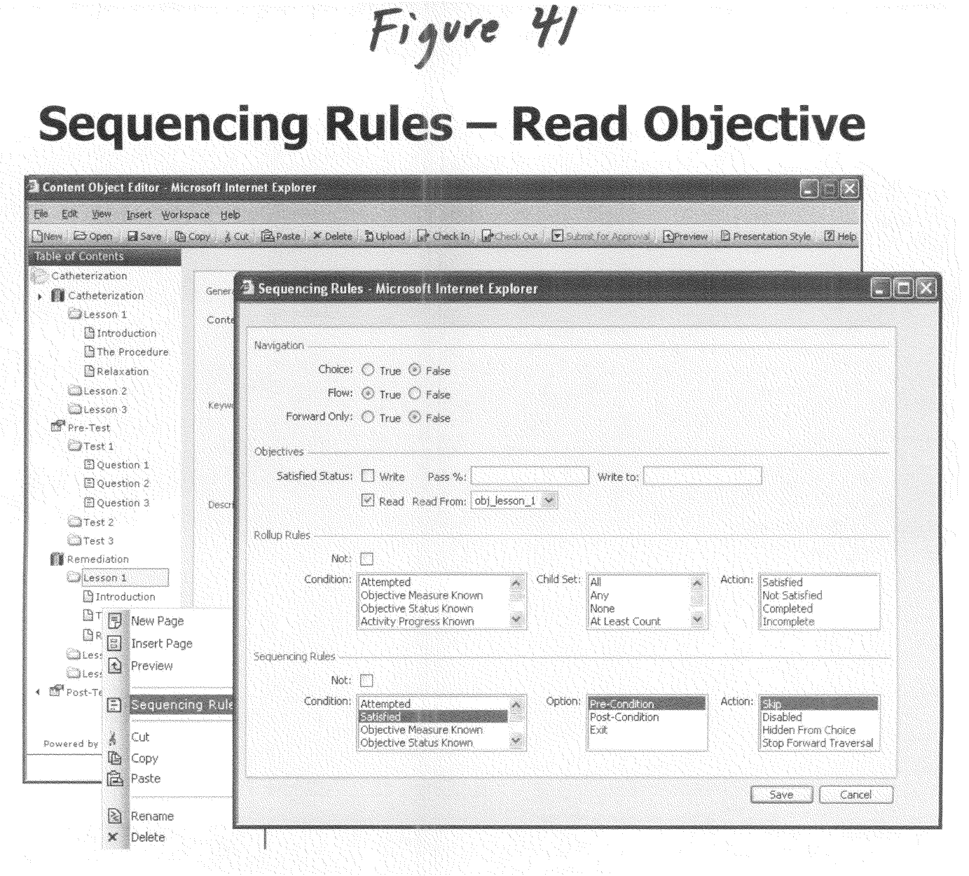

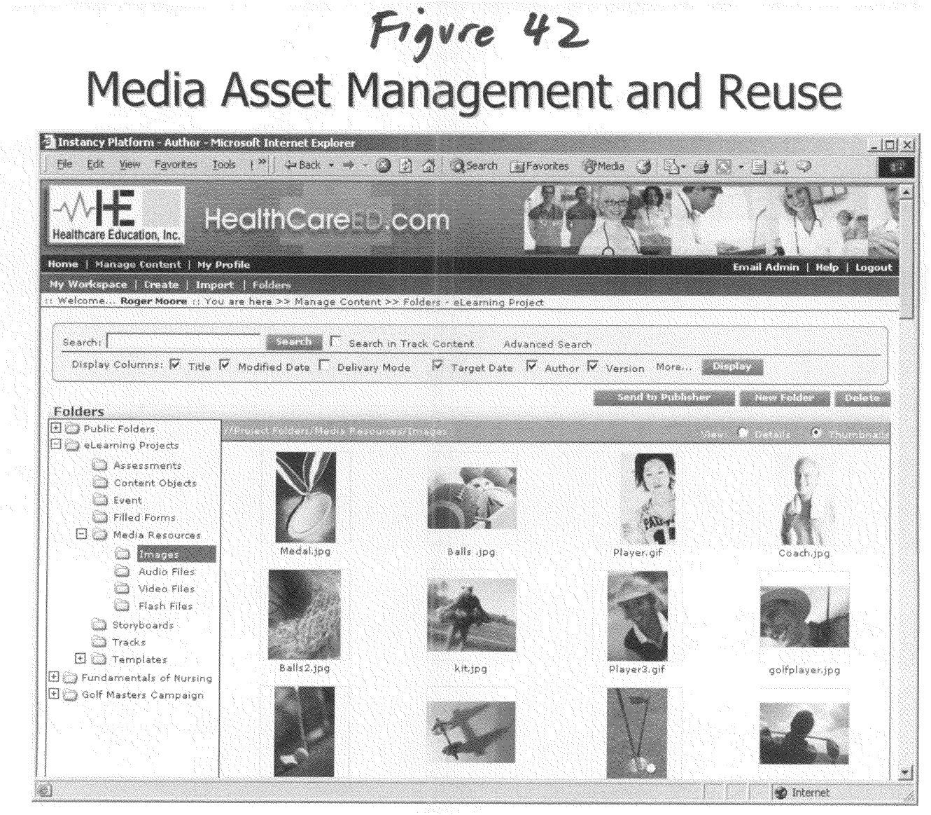

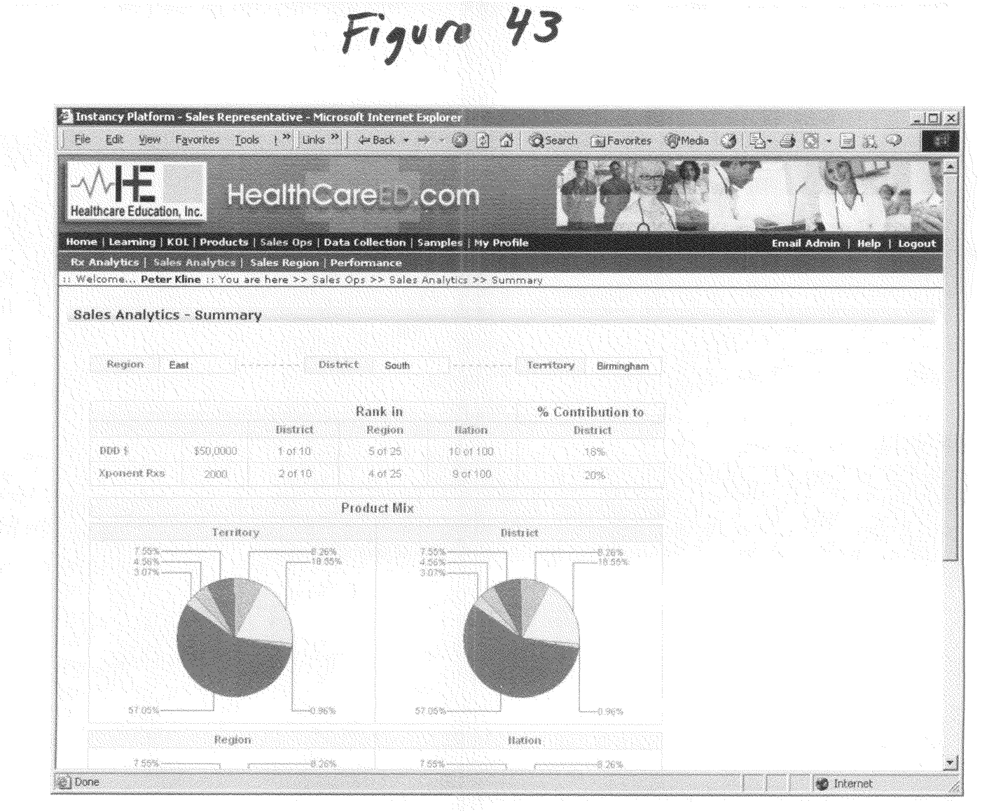

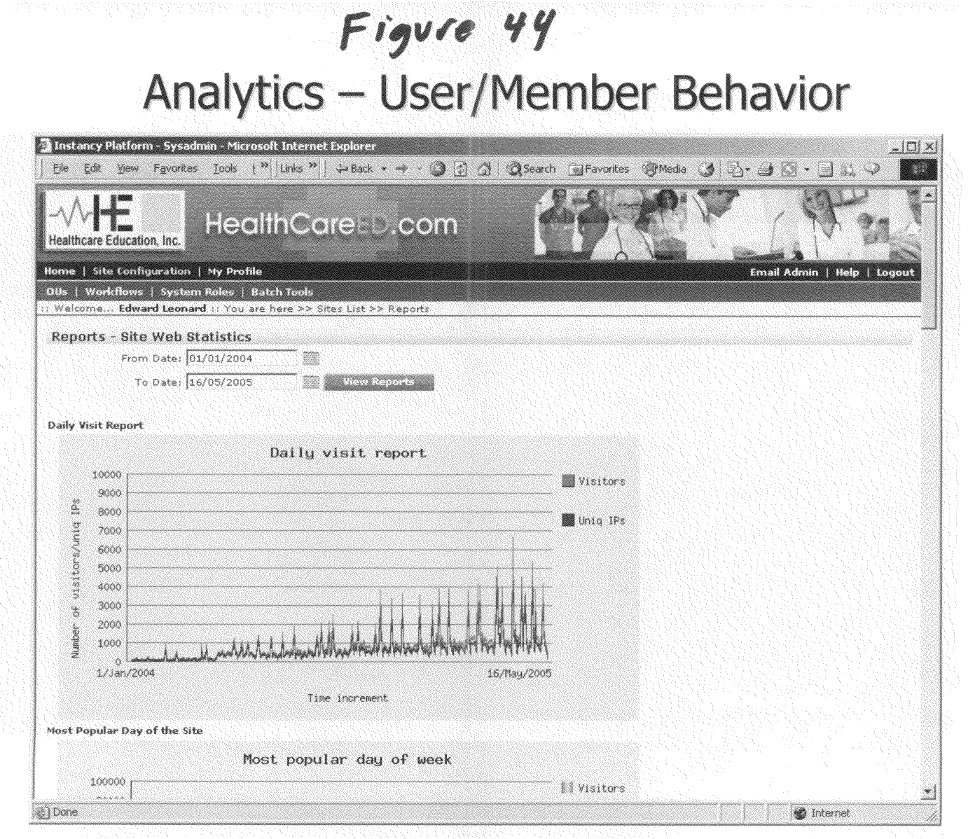

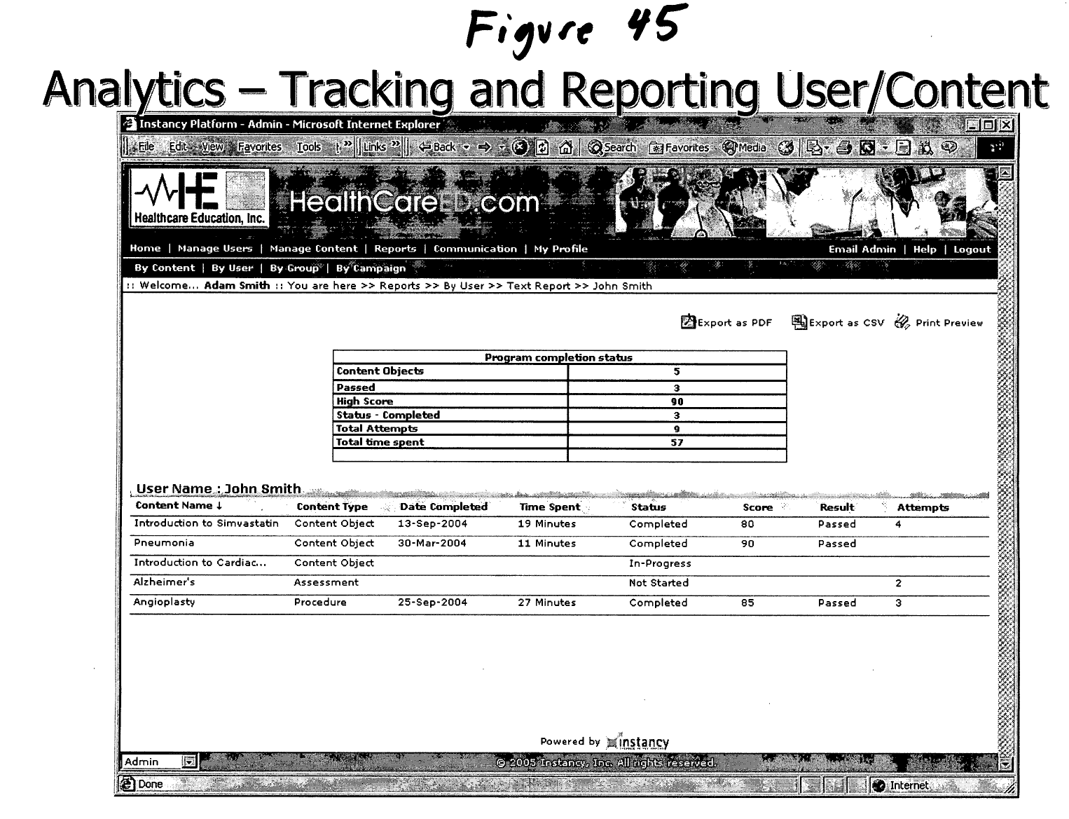

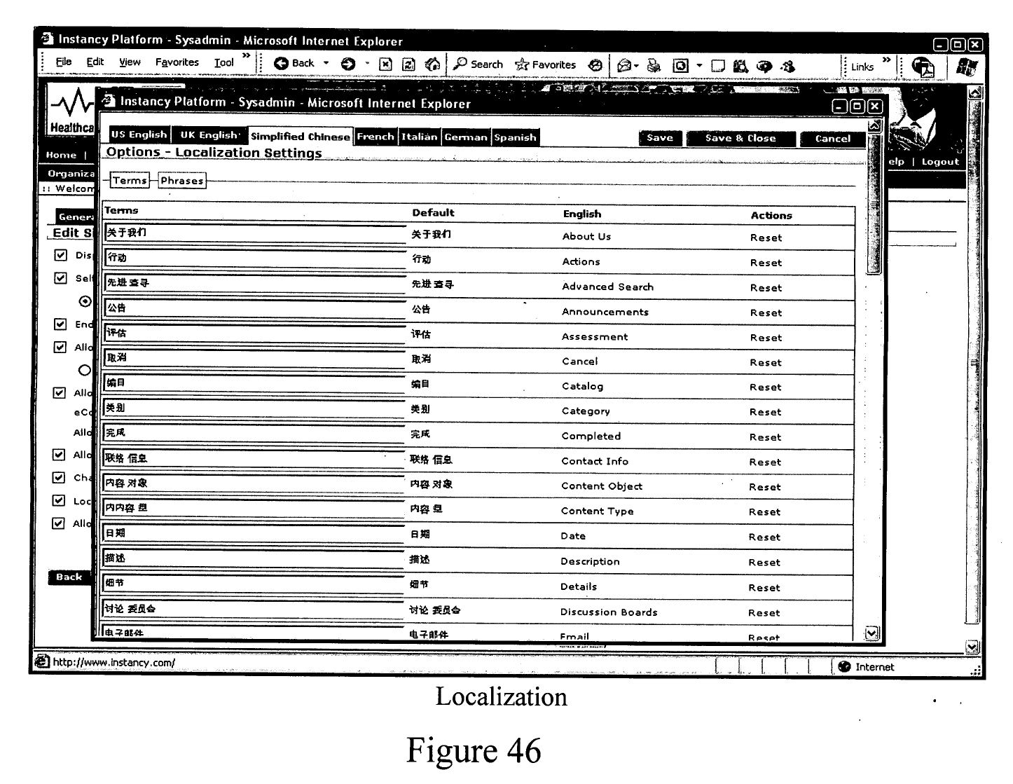

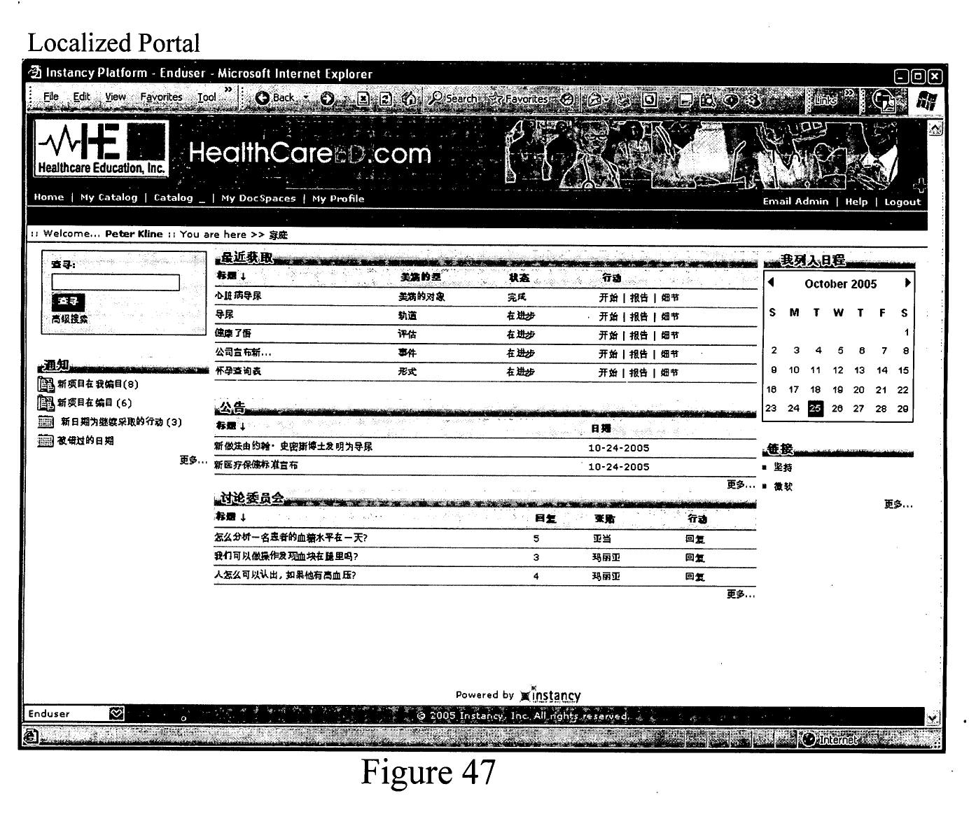

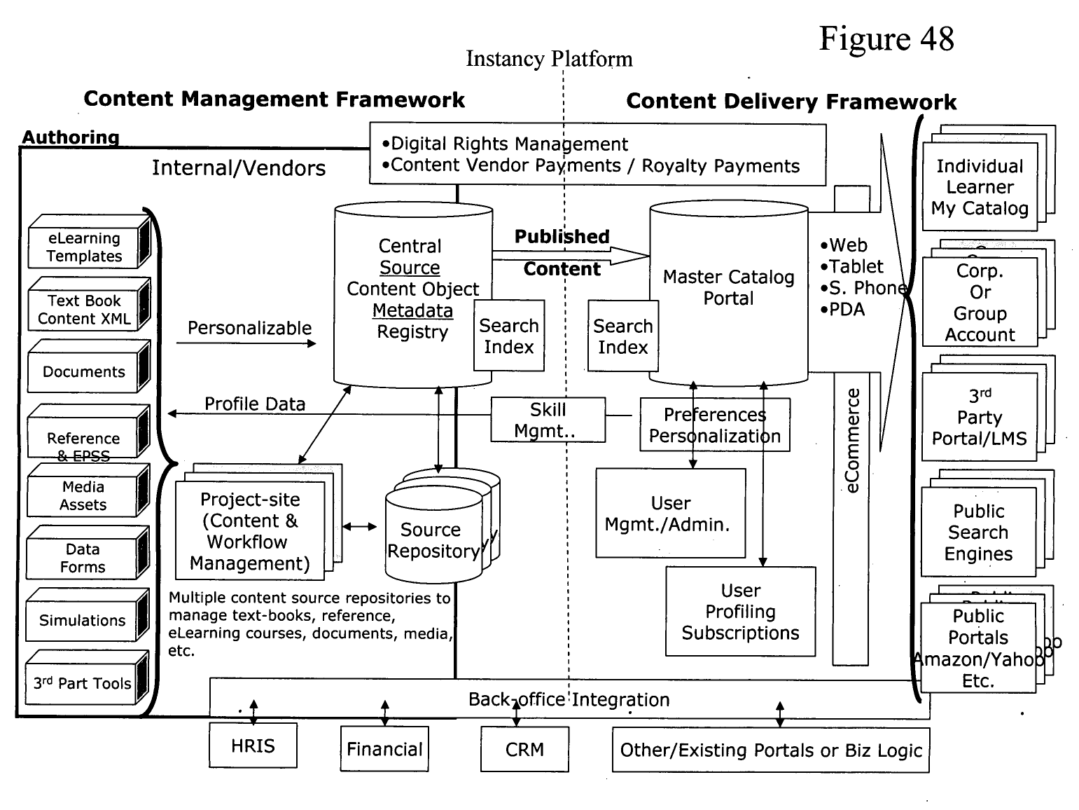

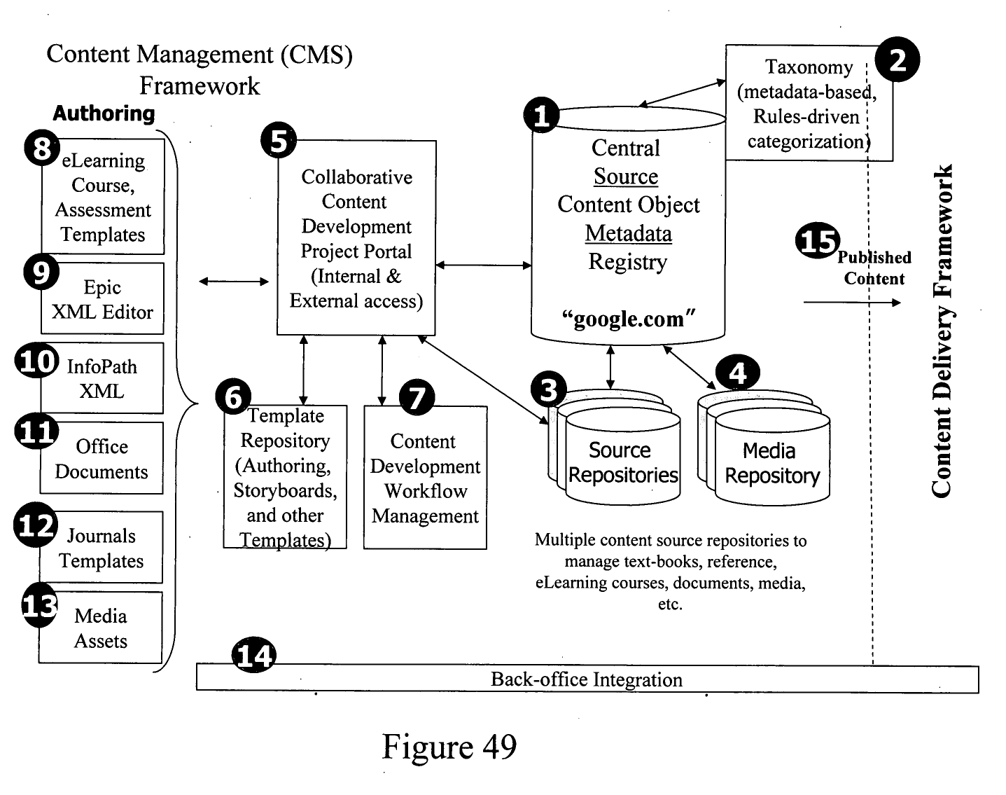

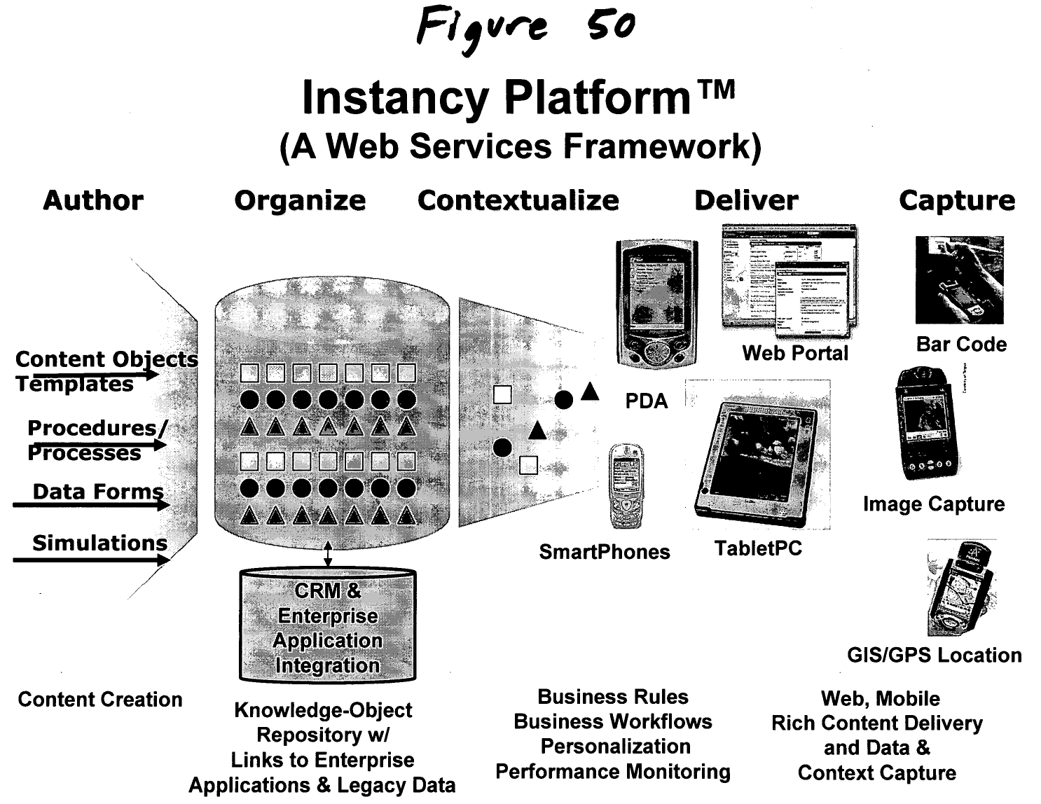

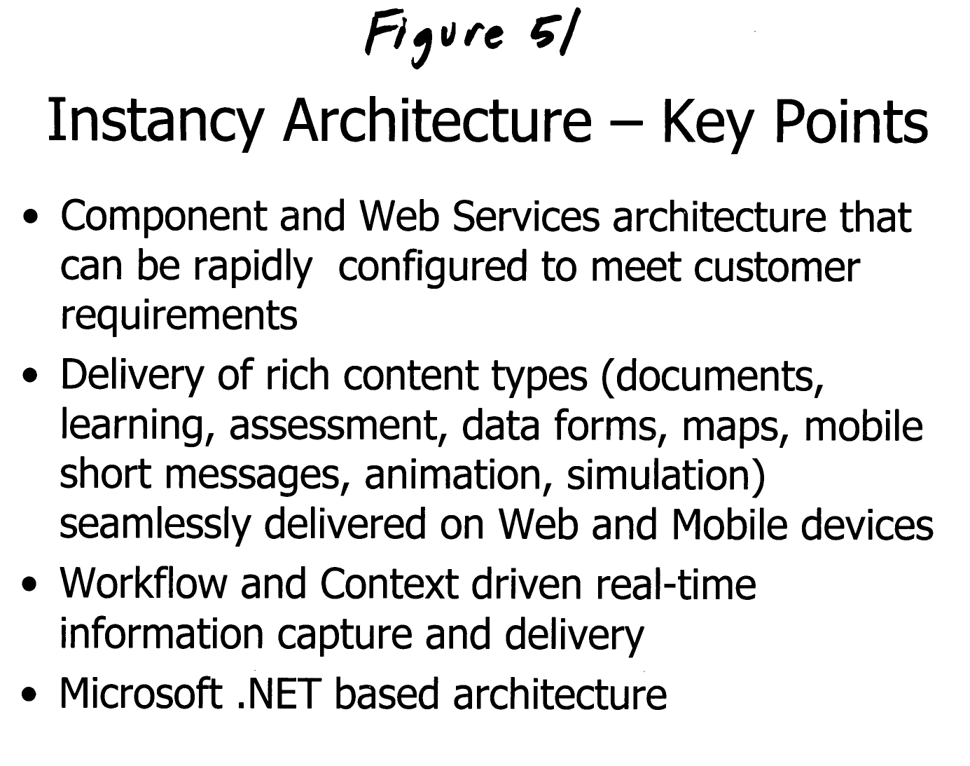

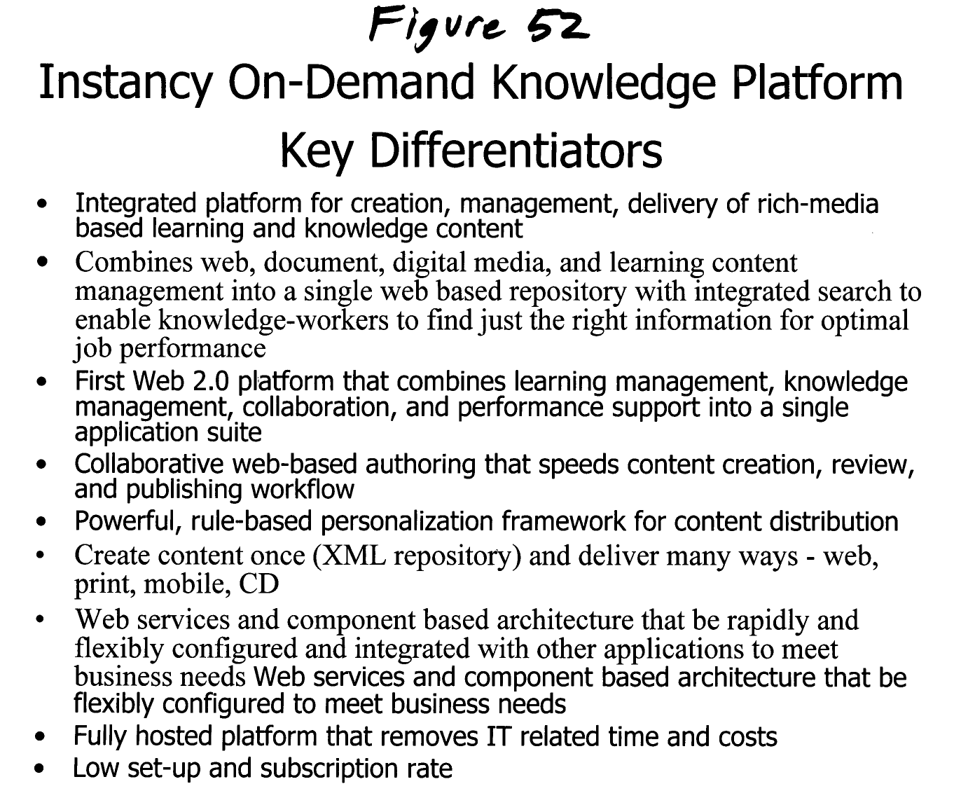

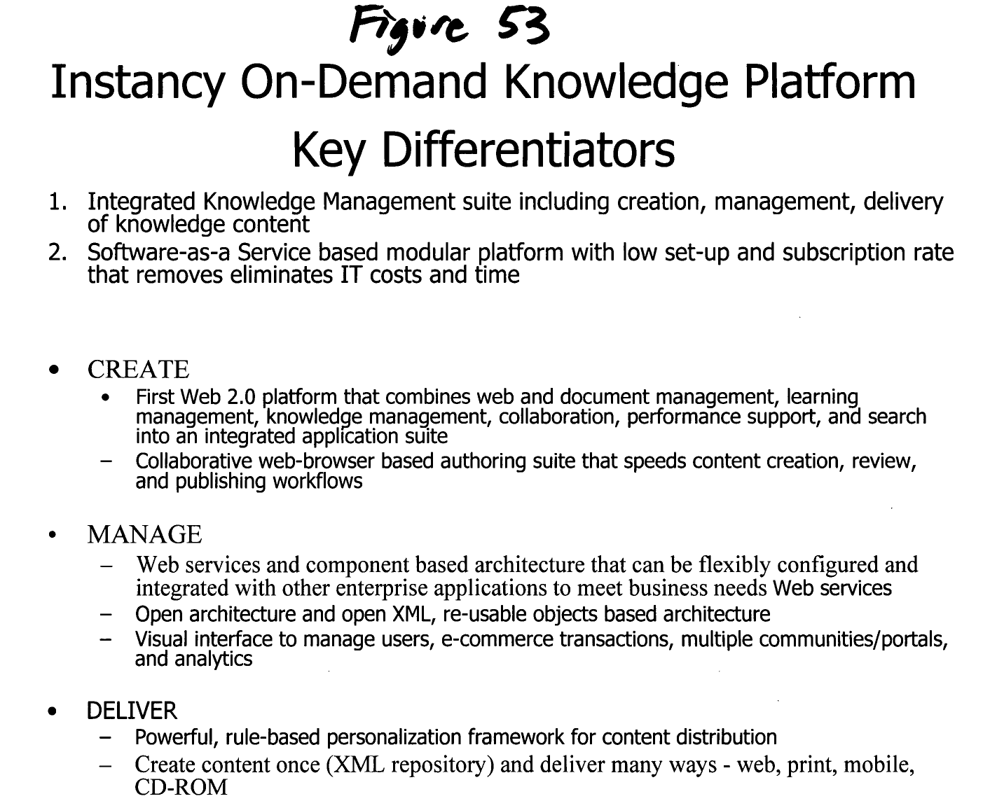

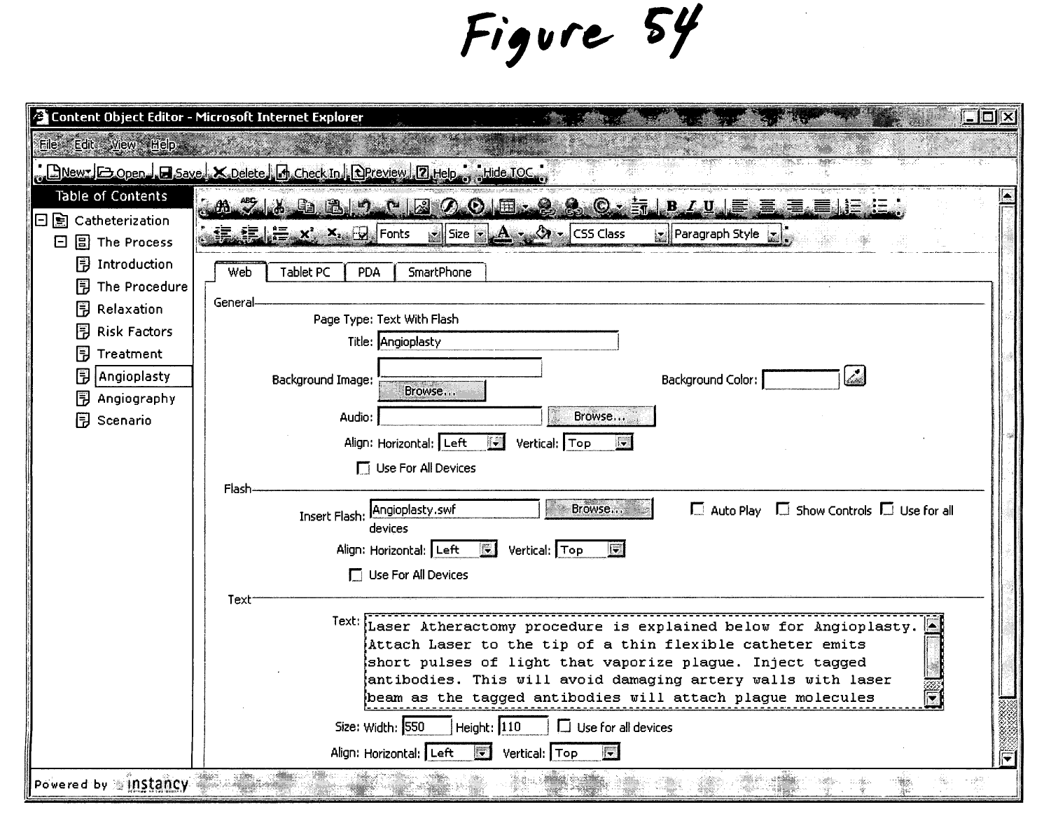

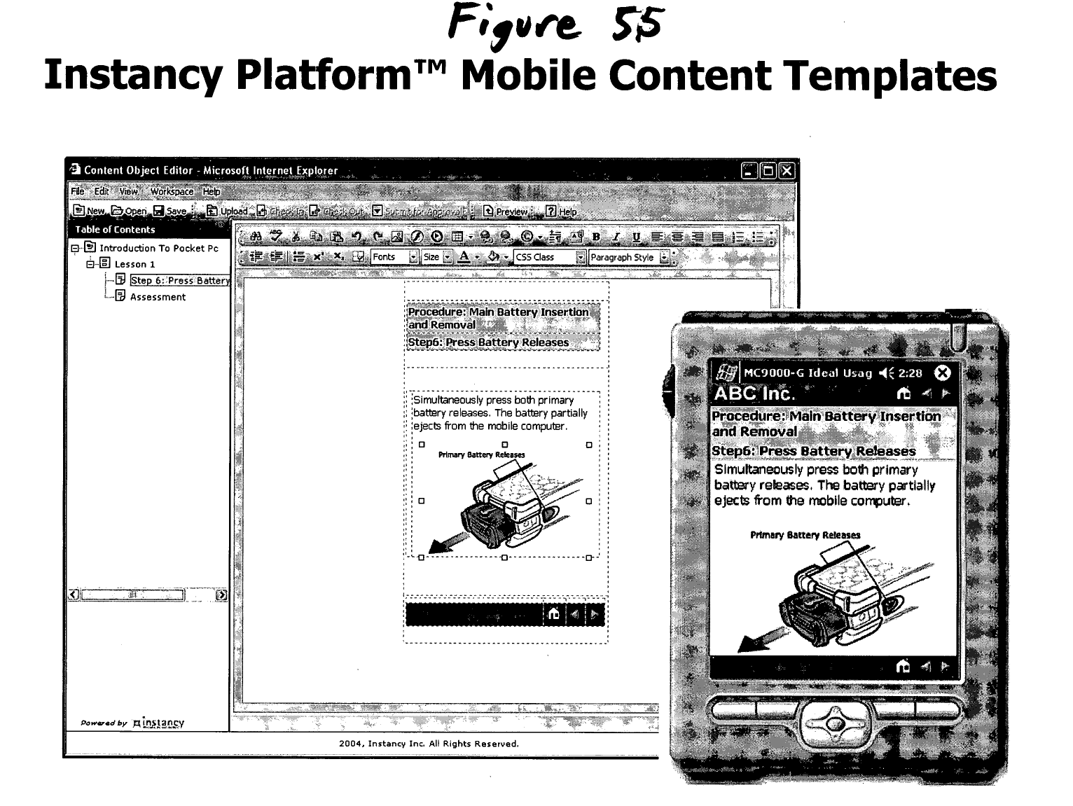

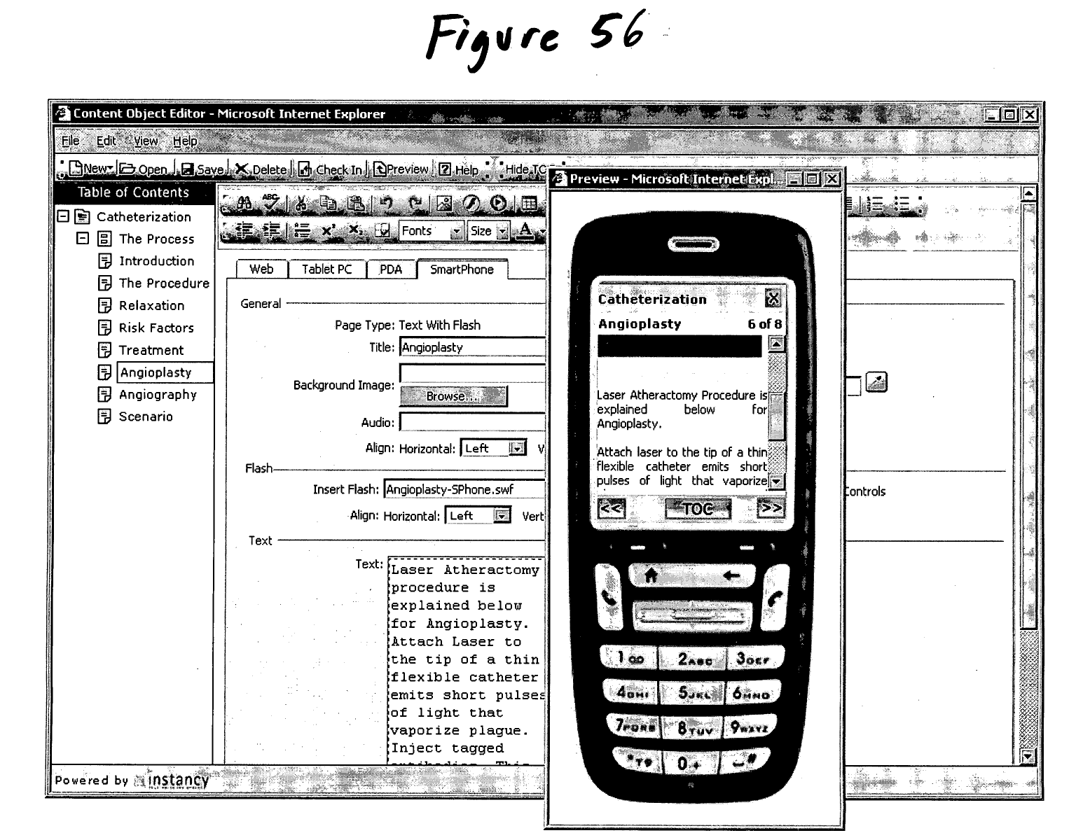

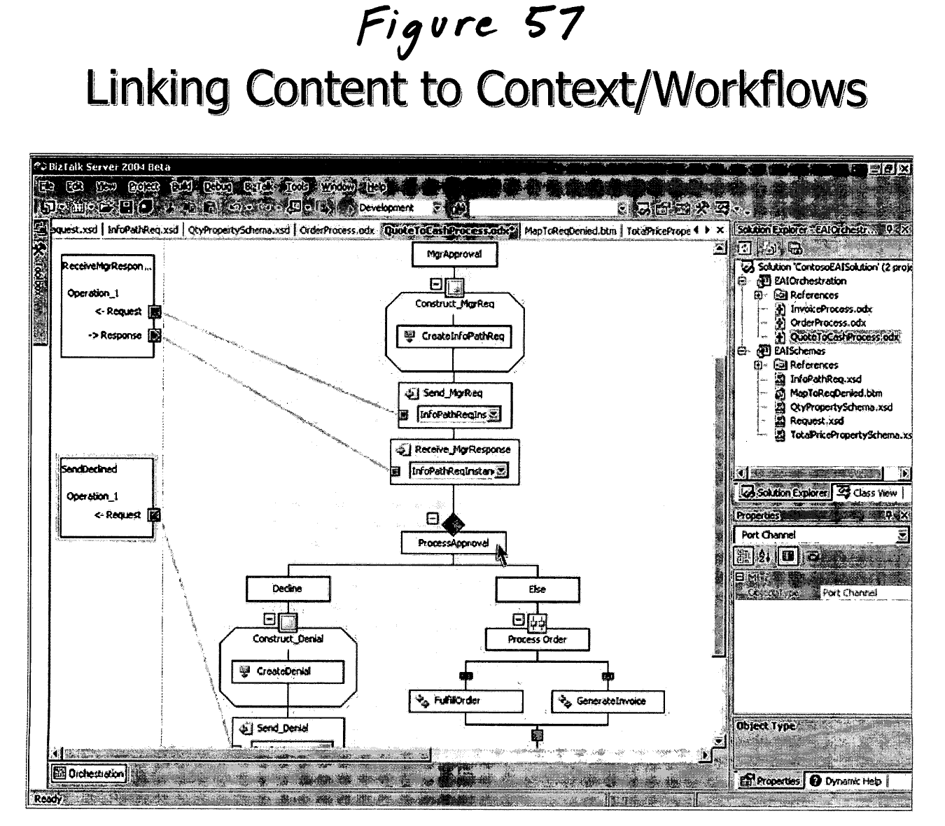

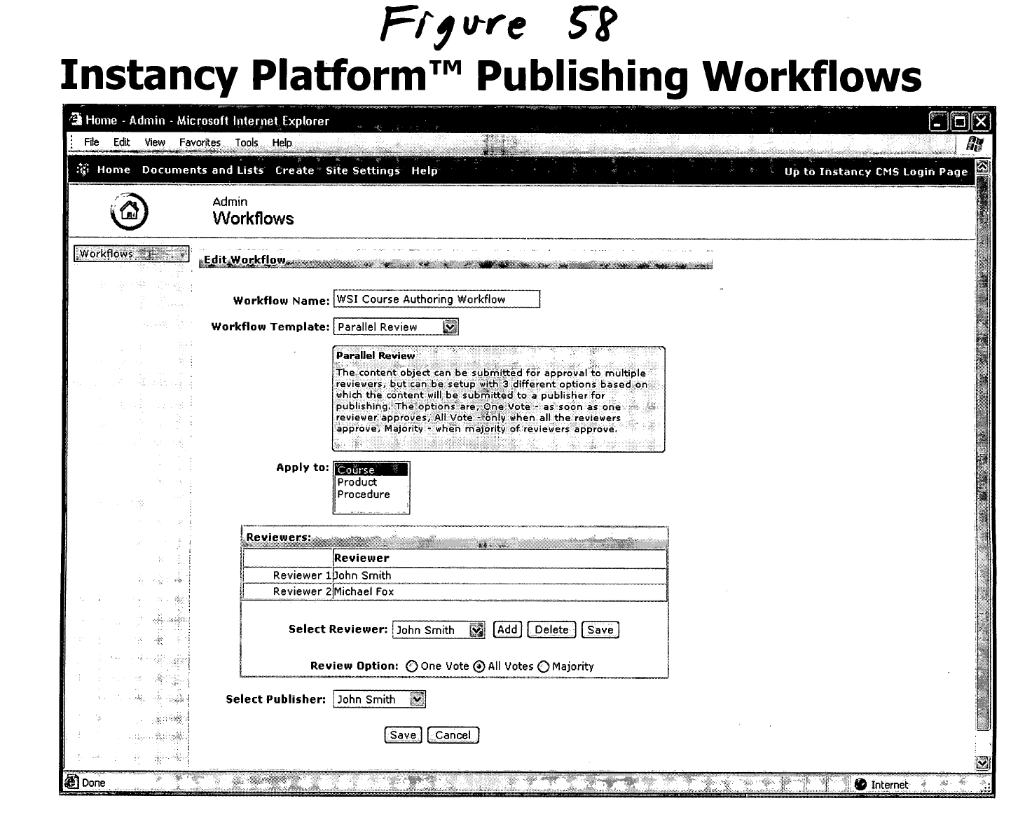

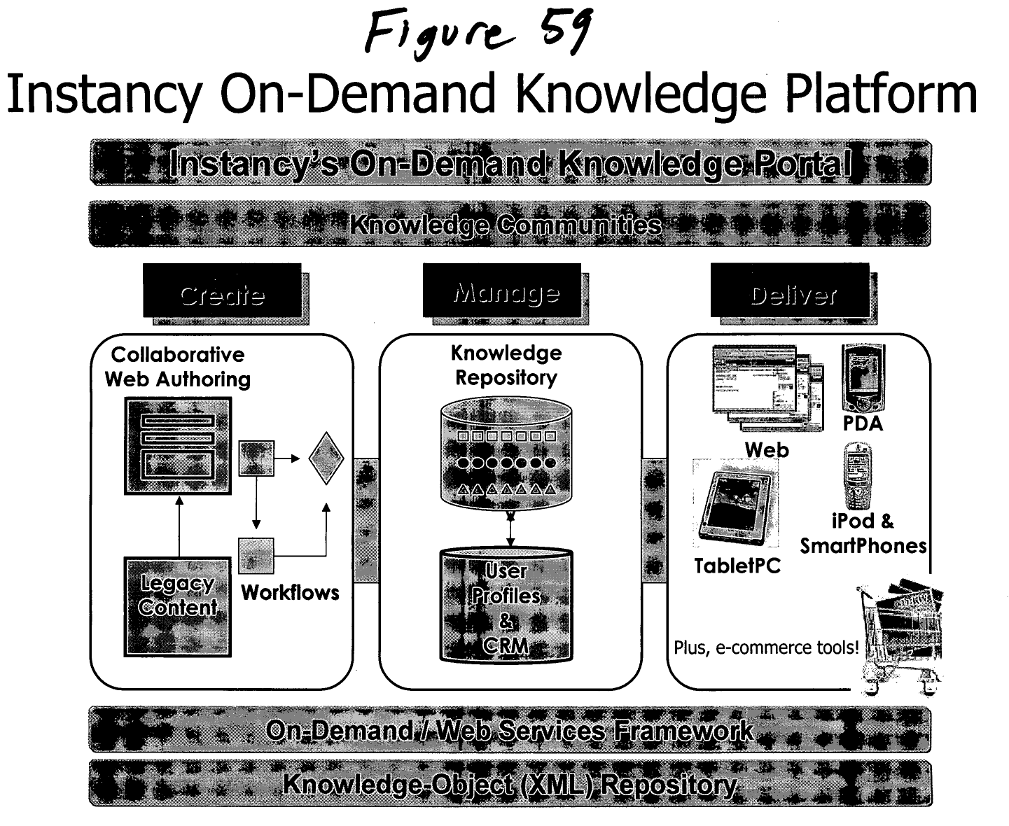

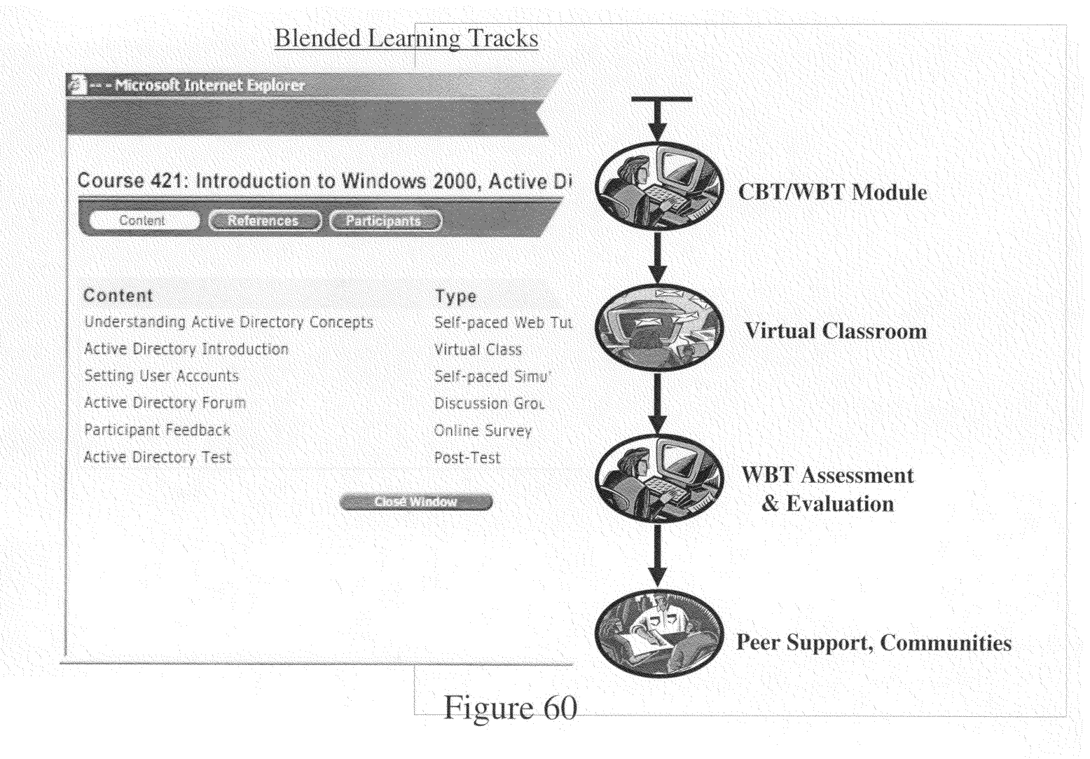

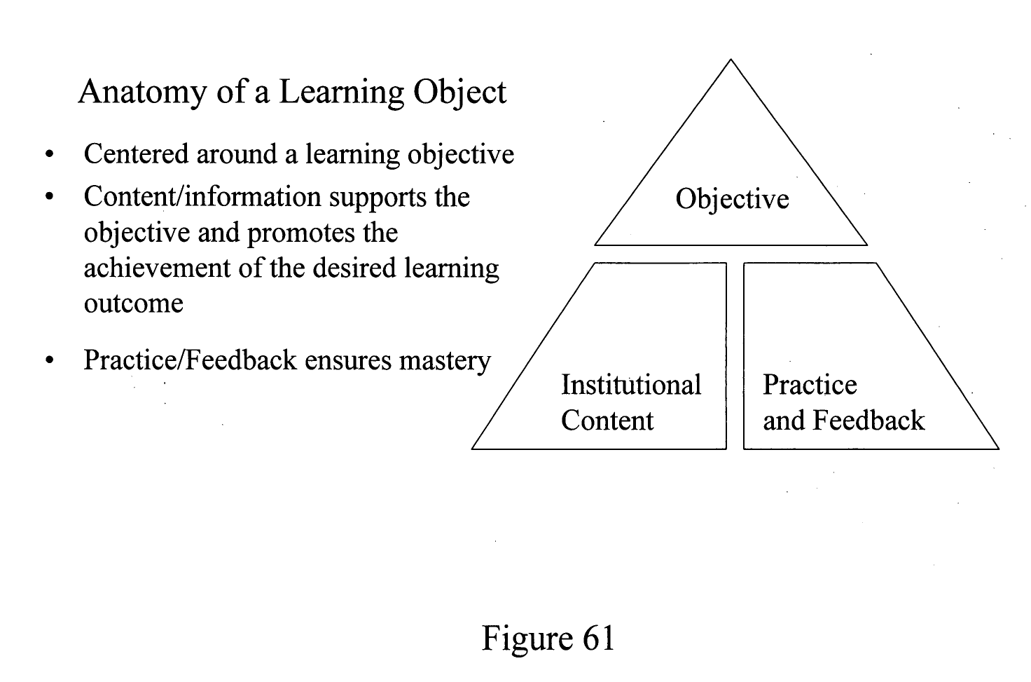

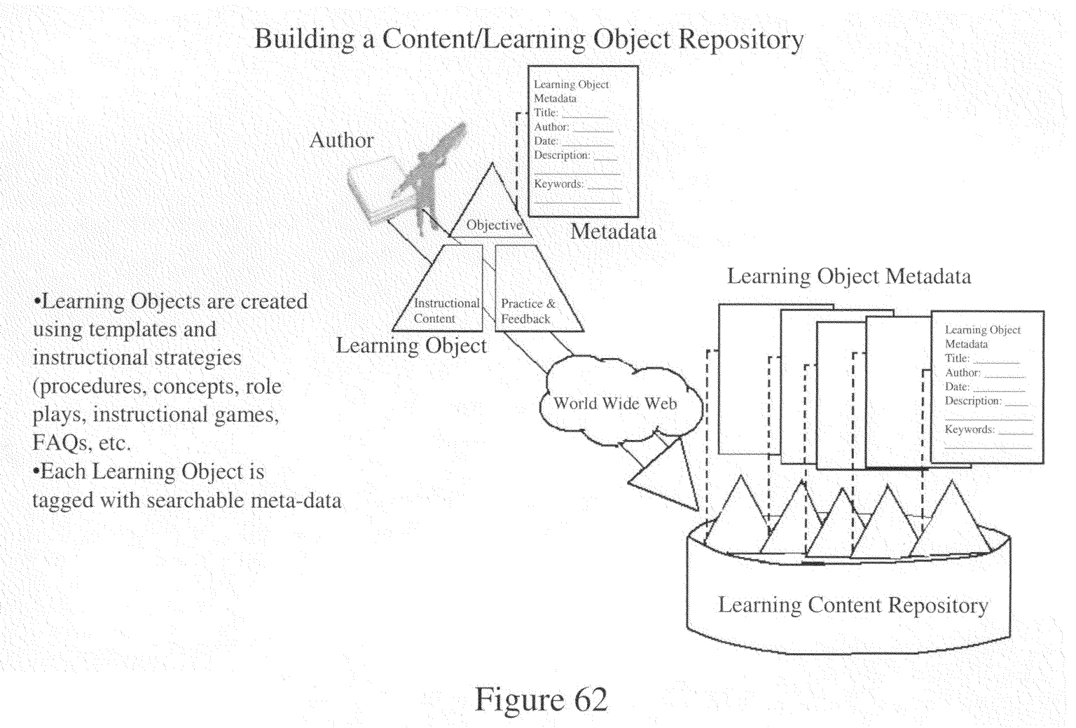

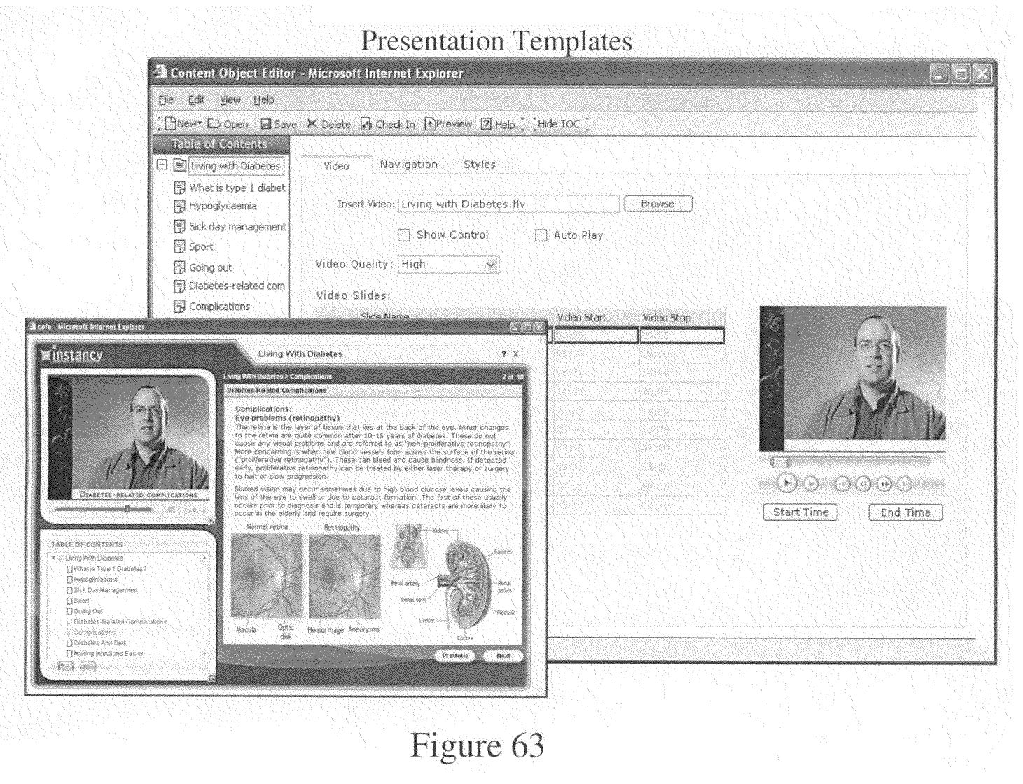

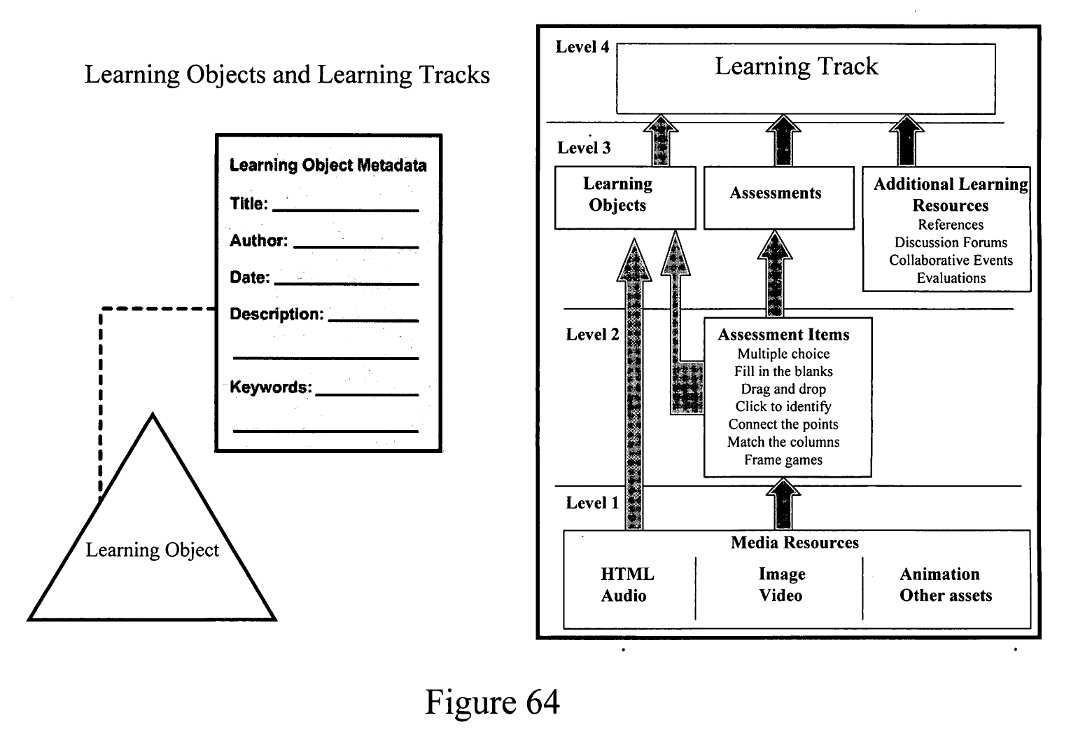

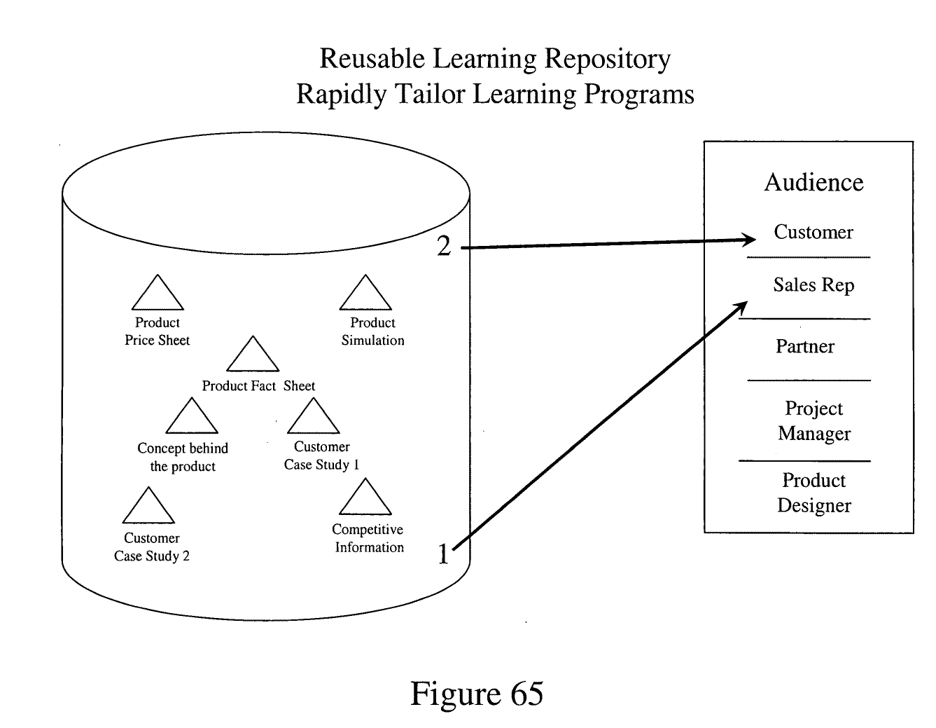

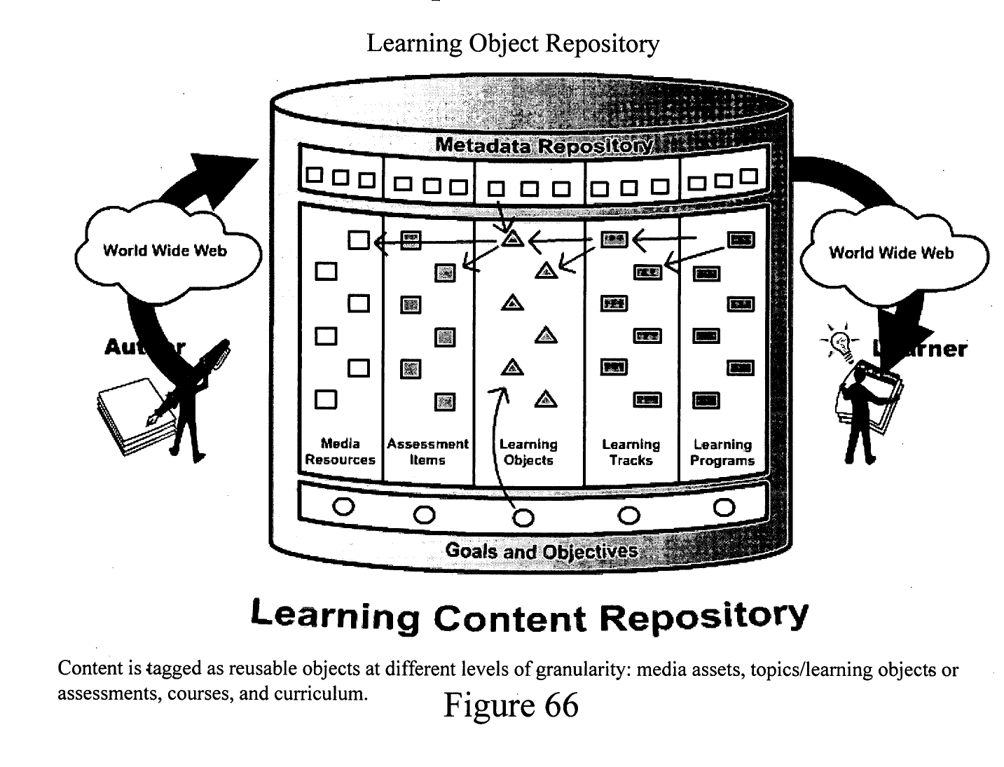

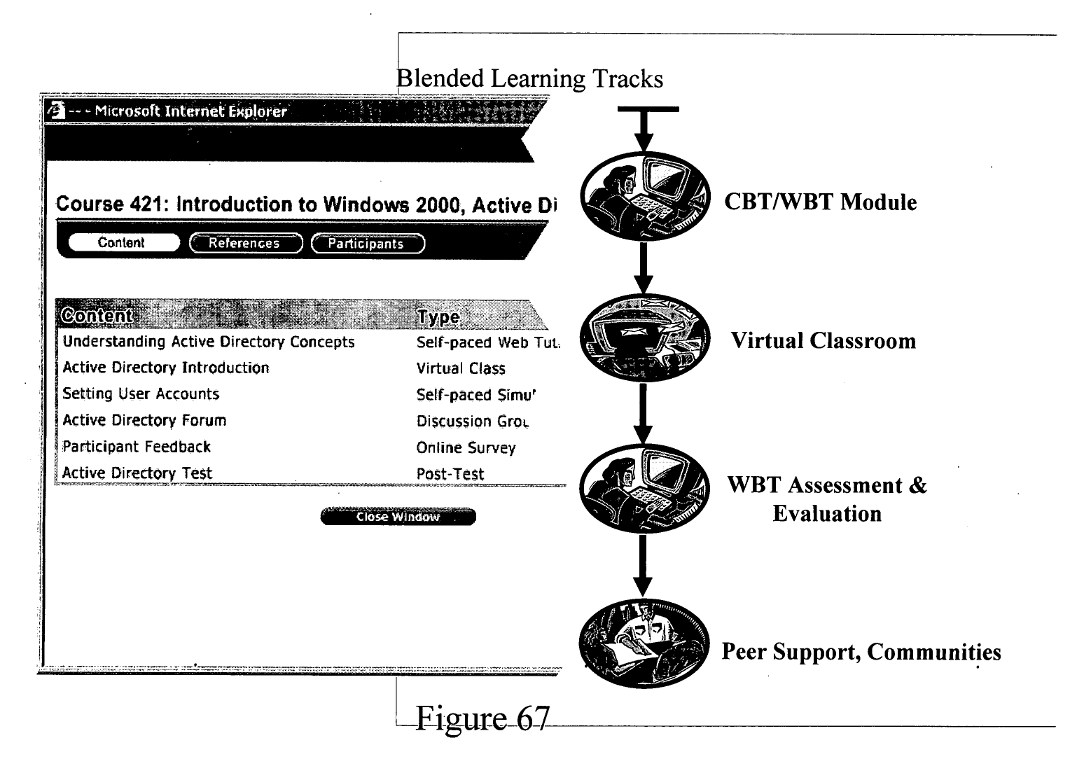

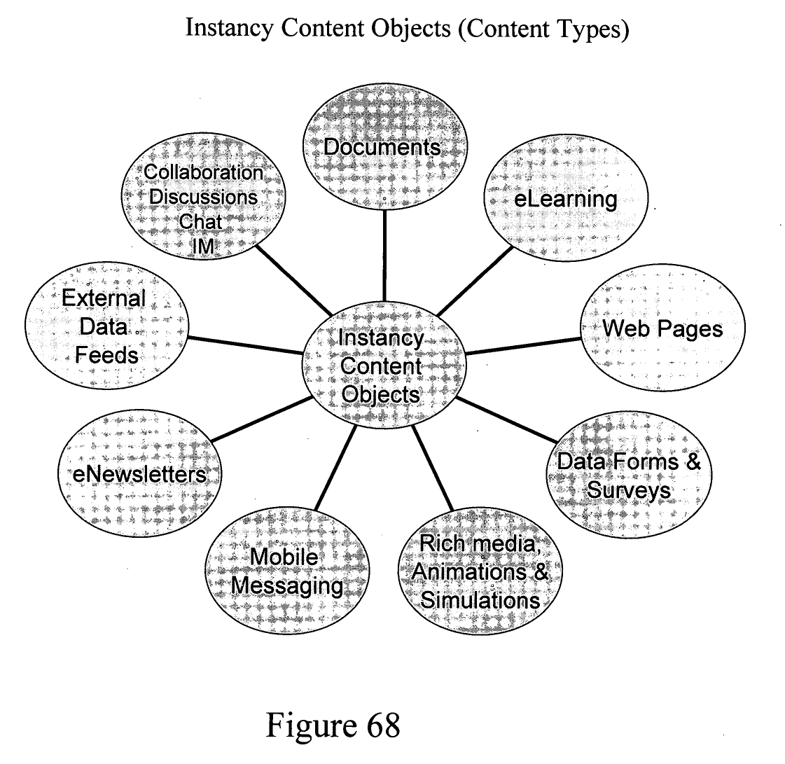

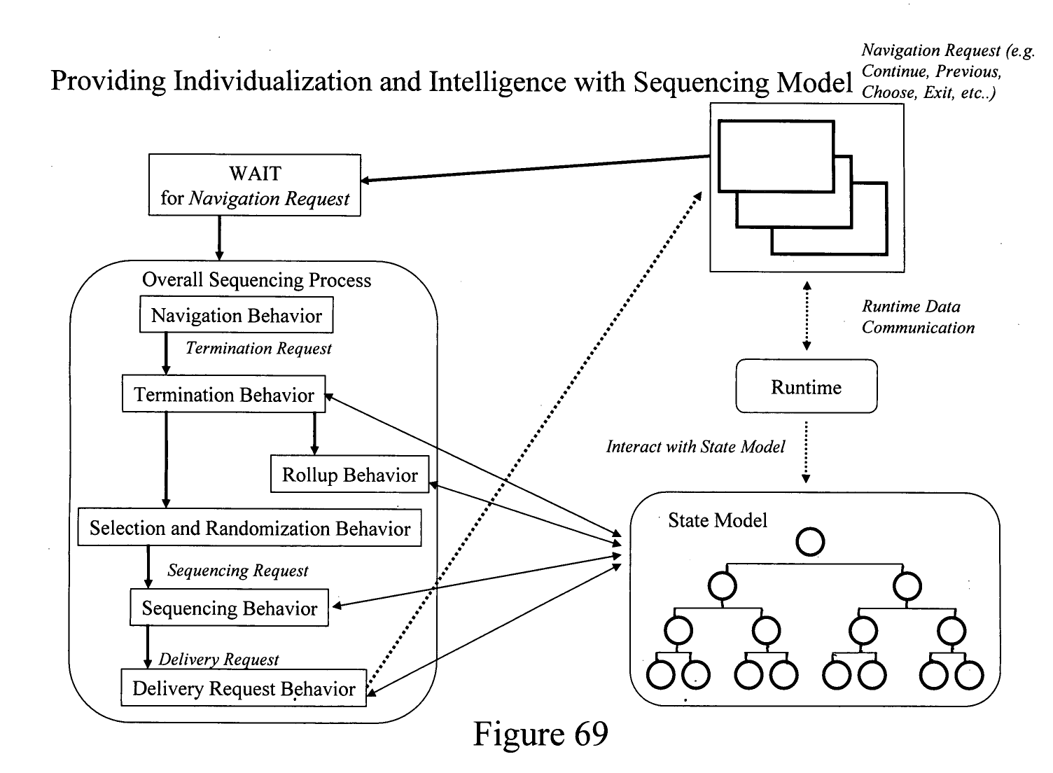

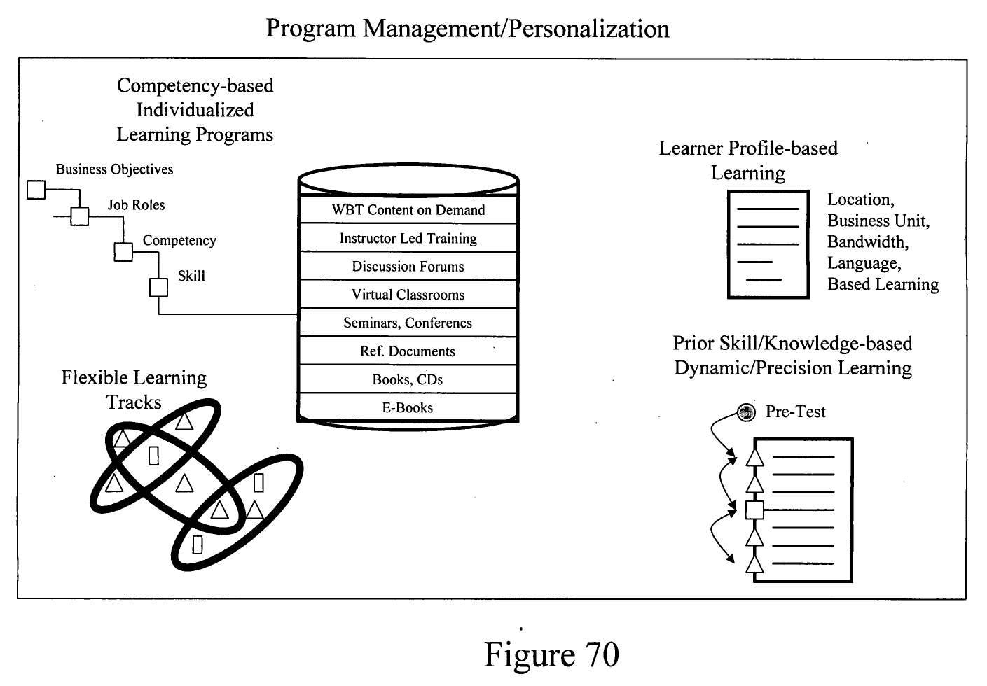

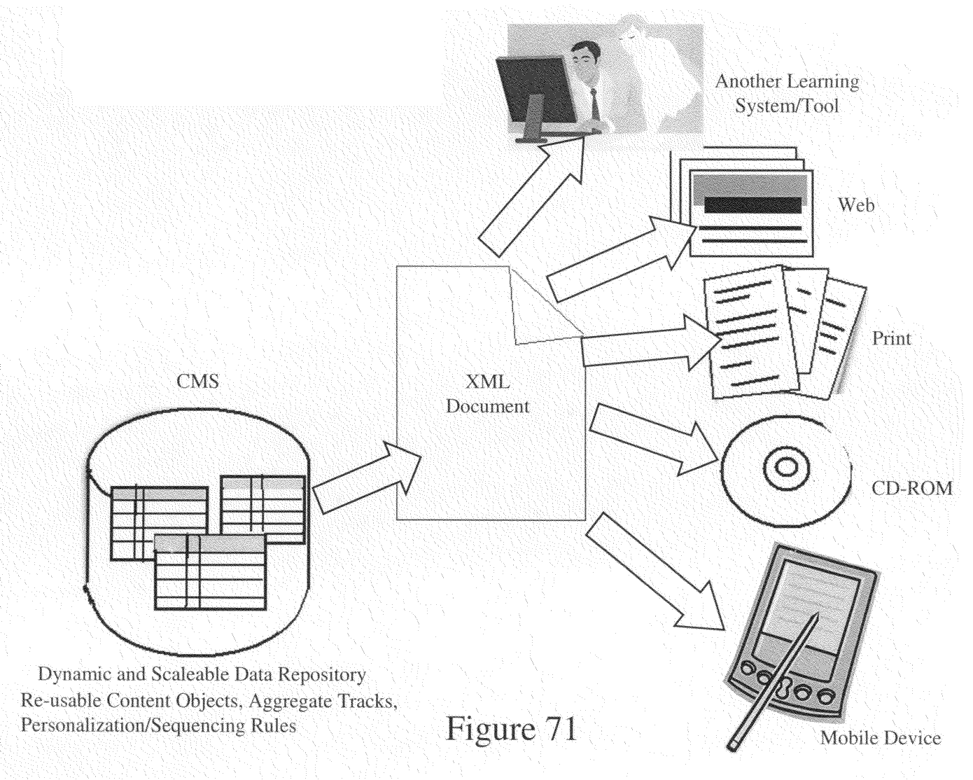

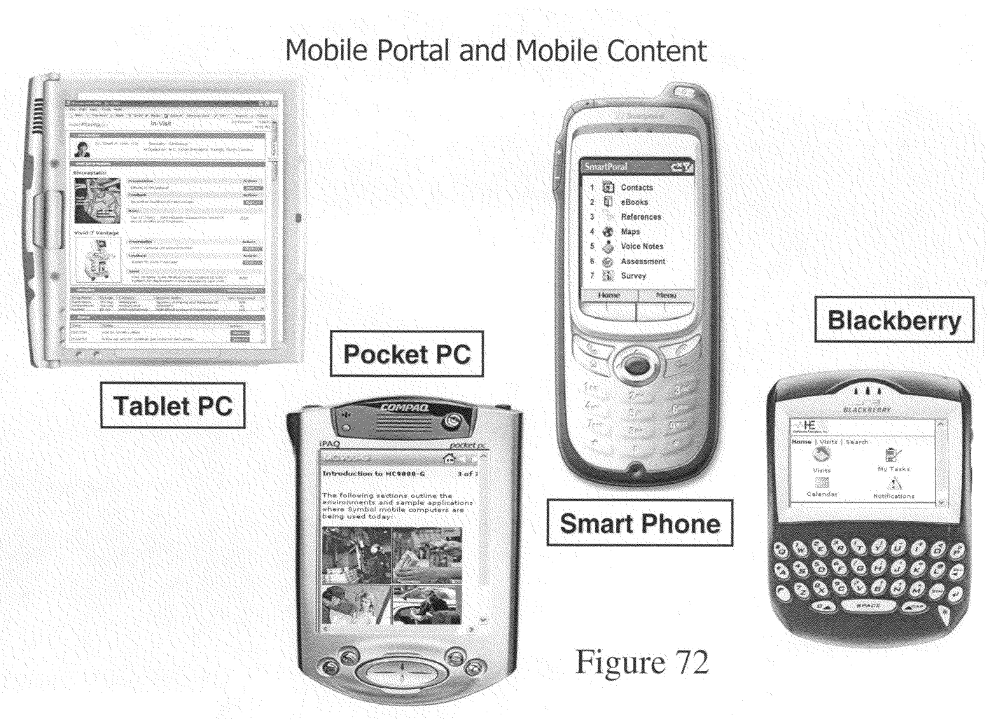

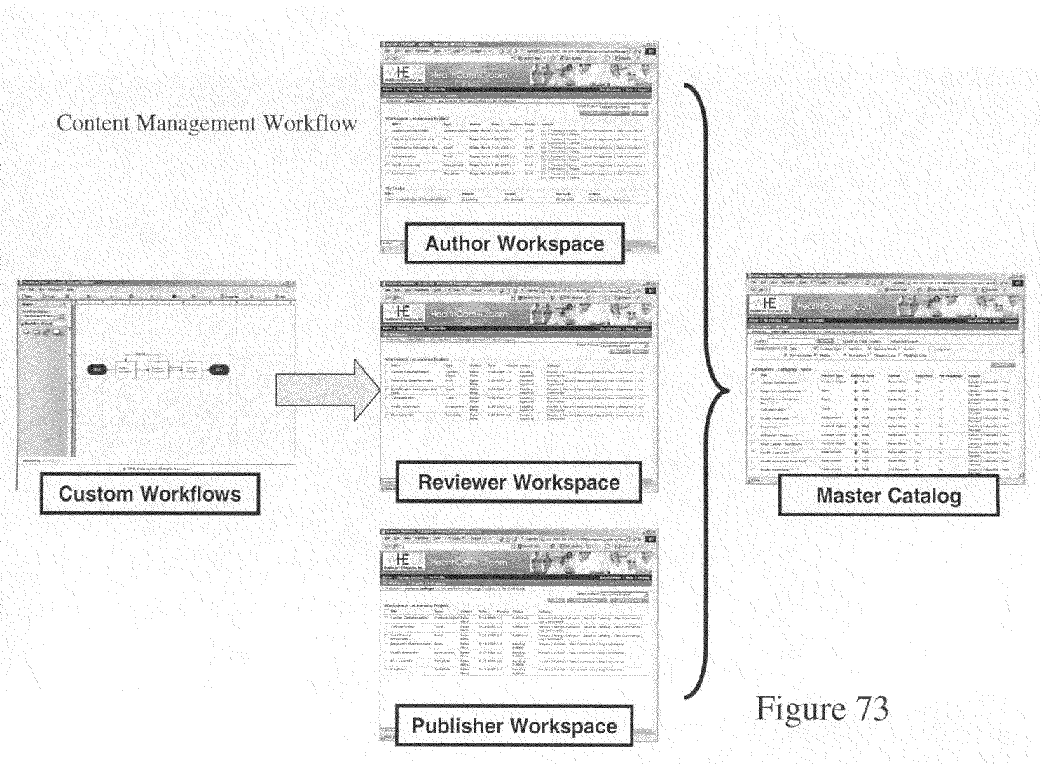

Referring now to the figures, FIGS. 1-73 provide schematic and flow diagrams relating to the present invention. FIG. 1 illustrates a schematic diagram showing components within the system according to the present invention, including a case study being provided as content for delivery over a network to an external customer support site through a community portal having authorized users with corresponding user profiles. Authoring templates are also shown for providing a format for authors to create content that is stored in a centralized content server or management system for network-based distribution to remote users of the system. FIG. 2 illustrates web authoring templates being provided with content in the central content server to remote users in a multiplicity of formats. FIG. 3 illustrates a knowledge community of users who access content of the system remotely, wherein the content was created using authoring templates for creating web-based content directly by authors/content creators. FIG. 7 illustrates a system having a combination of resources provided through a network and web-based content access, including interactive and dynamic content offered in a variety of media. FIG. 8 shows a flow diagram for an on-demand content platform including the steps of creating, managing, and delivering the content via plug-and-play applications through a network and portable computing devices capable of receiving and displaying the content, including audio and visual components of content. FIG. 10 further elaborates on the platform steps of FIG. 8.

FIGS. 54-58 show a screen shot or static display of a web interface and mobile device interface for users of the system.

Preferably, in the integrated web services platform for training, interactive content is provided to authorized user(s) through a web interface hosted on at least one server computer, the content being accessed by remote access device(s) that connect via a network or communications link. Remote, content access devices include audio, visual display, and user input functionality (via keypad, keyboard, touchscreen, click-select from dropdown, etc.) and include but are not limited to computers, PDAs, wireless communications devices, and the like.

Interactive Web Interface. Importantly, the system and methods of the present invention are preferably entirely web-based, from content development in a format-neutral embodiment to user personalization to content delivery in a variety of format options. Preferably, the user access is through a network in communication with a server computer, more particularly, a user accesses the system with a remote content access device through an online web service that is web browser-based (so that no specific client software is required on the content access devices), which facilitates user access from anywhere at anytime.

Users of the system access it for different reasons. Users include end users, who access the content delivery at the “front end” of the system; these users subscribe or pay for the service. Training or end user access to content delivery is provided by a user account that includes a user identifier that is preferably unique to each user or, at a minimum, unique to each class or group of users. For the maximum personalization of content, unique user identifiers and corresponding user profiles are required. Users also include “back end” users, such as authors who generate content, including both sub-content or content objects, and composite content; these content generation users have a role-based access with certain privileges and permissions for content access to create, edit, combine, delete, and combinations thereof. Other back end users include content management users and content delivery users. Importantly, the differentiation of users with controlled, predetermined access and the parsing of roles and functions including format-neutral content development, content-neutral format development, content management, content delivery and end user access, together uniquely enable the completely web-based system of the present invention. Thus, the authors create and store all content (subcomponents or content elements) and content objects in format-neutral embodiments on the system so that it is accessible by other authors and recombinable to form new composite content easily. The content is stored and cataloged so that it is searchable, rankable, etc. No prior art provides for a comprehensive, interactive system that is entirely web-based.

Personalized Content Delivery. Preferably, the interactive training content provided in the systems and methods of the present invention includes personalized information to each user and/or group of related users. The information is personalized through a series of activities operable through the web interface to determine the user knowledge level or status at the initialization of a first session or any predetermined subsequent sessions of interaction on the web interface. The series of activities include interactive engagement that require the user to perform functions such as to read and/or to interact or engage the system through a series of prompts and inputs, or questions and corresponding answers, or combinations thereof. Based upon the user inputs to the series of activities and the system analysis thereof, the system adapts its format of content to the user knowledge and/or proficiency.

Modularized Content. By way of definition, the term “content” as used herein includes substantive information without regard to its format; by way of example, it does not mean a single graphic image or screen/display view for a visual, which is actually content in a specific form or format. As used in this description, “content” refers to small objects of substance or subcomponents that are modularly recombinable and reusable to form composite content. The composite content that is ultimately displayed or presented to a user in content delivery is presented in a specific format; the underlying format-neutral composite content is also referred to as “content object” in this description.

Content development within the system creates content that is separate and distinct or independent from the presentation format of its substance. Importantly, since presentation aspects are separate from the content, content is not recreated but adapted to particular formats of presentation; thus, the same content substance may be mapped to different presentation formats and styles. Presentation layers are formed by the rendering of format-neutral content by different methods into different end user experiences. The content-neutral substance is preferably stored in XML so that it can be rendered into other formats easily and automatically. Format as used herein means content type, such as web, html, flash, print (PDF), mobile, etc. as well as the mode of delivery or presentation, such as video, still image, drawing or rendering, audio, text, table, and any other format type, language, and combinations thereof. Multiple variations of the formatting or presentations may be used by the content designers for example the content designer may select html and two variations for print output one with speaker notes and one without.

Most significantly, the initial content developed is format neutral, i.e., the content is initially developed or provided independent of and separate from the format in which users will ultimately view and/or interact with it. Small objects of substance form the base content of the system and are developed by authors and classified by substantive area and category. Categories for content are based upon the type of function they perform, such as media resources, including dynamic and static types; assessment items; and additional learning resources. Composite content is combined and recombinable substantive content (subcomponents) that become content objects that are later rendered into specific formats for delivery. Learning objects and learning tracks that provide different content based upon user needs or customized programs are illustrated in the figures.

Content may be further categorized and offered to particular groups of interest that comprise users of the system that have opted-in or that have been invited to join, such as an interest group, a company, a division within a company, etc.

Preferably, the format-neutral content and its development is provided by a multiplicity of authors such that content components can be combined by other authors to create additional, different content and such that content components can be arranged and rearranged in different series by a rendering engine that intakes content and generates format-specific content suitable for delivery to the user(s). Preferably, there are a multiplicity of rendering engines wherein each of them generates different formats for whatever content is desired.

Sequencing Rules. Preferably, sequencing rules are used for providing modules of content in more than one order to personalize it to different users

Rendering Content into Format for Delivery. Preferably, according to the present invention, a rendering logic provides for content neutral format options. A variety of formats or form-specific options are selectable to present content objects or composite content to a user accessing the system remotely by a web-accessible or web-operable content access device. The format options are preferably provided to optimize the user experience on a given content access device; the user can access the content at different times using different devices and the system adjusts the delivery format accordingly so that the content delivery is most suitable to the limitations of the particular device in use at that time. The system may prompt the user for input relating to identification of the type of device or the system may automatically detect the type of device.

Referring now to the figures in general, the illustrations are for the purpose of describing a preferred embodiment of the invention and are not intended to limit the invention thereto. As best seen in the figures, schematic diagrams of the system and user interface visuals or screen shots of a display are shown to illustrate the features and functions of the web-based training content development, management and distribution, including digital rights management according to the present invention.

Content Authoring and Management. The systems and methods of the present invention provide four key elements within a common, integrated content framework, namely: personalization, sequencing, content, and presentation (format). Content personalization is functionally enabled by the integration of content authoring, development, and delivery within a single interactive web platform wherein the content is created, managed and stored in a format-neutral manner until presentation to a given user. The sequence of content objects or resources is based on a prescriptive and adaptive logic. The present invention systems and methods are operable to provide for and to save the sequencing of content by each user. This enables users to proceed with content review or interaction in a book-marked manner, i.e., the user exits the system and reenters or picks up with prior accessed content where they left in the previous session. Also, the user can refresh or quick review the content accessed just prior to terminating or exiting the previous content access session before proceeding with new, unexperienced content. Tracking content access with the sequencing methods and rules of the present invention are definable independent of the content so that content objects may be reused or recombined in other orders. Sequencing rules flow is illustrated in the attached figures, with different sequencing for the same or similar content combinations. In this manner, multimedia content is provided to the user in a personalized manner wherein the format-neutral content is rendered into a specific format for presentation at the time of content access by the given or particular user, based upon the user's personal status, goals, etc. Additionally, on top of various multimedia format options within which the content is presentable or accessable and interactable by the user, the present invention further provides presentation skins or skinned user interfaces having graphic user interface characteristics that are customizeable for branding, group-specific identification, and user preferences, by way of example and not limitation, the skins may include a navigation panel, a background, a style, a logo or branding, etc. that is user-specific or group-specific.

Advantageously, while the four key elements are provided within a common, integrated framework, each is managed independent of the others: the format neutral content is managed a reusable content objects, the content presentation layer, content sequencing rules, and profile based personalization rules. This offers enormous flexibility and advantages of current systems: (i) the same content may be presented in different formats and presentation styles without needing to be manually converted or re-authored simply by applying a different style or rendering engine (that adds the presentation layer to the content). Additional style templates or rendering engines may be added in the future without upsetting the existing content. (ii) by separating the sequencing rules from the content blocks or objects, the underlying content objects may be re-used in different training programs without needing to manually remove the sequencing rules specific to any particular training program. (iii) by separating the user profile based personalization framework, the same framework may be leveraged by multiple programs and each program may be tailored to individual needs.

Multi-mode rendering provides multiple rendering engines that are available; new rendering engines can be defined (HTML, Flash, PDF, FlashPaper, Mobile, future, etc.) and added to the options at any point in the operation of the systems and methods of the present invention. Each rendering engine defines the automation rules or programming logic for interpreting the format neutral content and present it in different formats. In addition, presentation styles may be managed through presentation templates (presentation template library) that may be applied to the content by the rendering engines. Each rendering engine (or software module) may be added without interfering with the existing content even bringing the existing web based training system down. While the rendering engine may automate the content formatting process the rendering engine also provides a visual interface for the content designer to review the content and make any adjustments before publishing the content in the desirable format by simply selecting the appropriate content format. Content Template Libraries. The present invention further provides for multimedia elements to be added to content pages, whereby audio/video and animation, graphics are synchronizable. Preferably, a library of content templates is available as a selection option and operable for an authoring user to quickly create content that is format-neutral without having to write any code or programming scripts. The author users may optionally add their own templates into the library, which expands content options for that user, and optionally for other author users of the system, based upon access privileges and other factors. These content templates further include template elements, such as by way of example and not limitation, database queries, web service calls, multimedia elements, user interactions or annotations and links or referenced to other content. The content templates preferably optionally include game and simulation type activities enabling the end-user to interact with the content and multimedia elements presented within a web browser.

Server-based Content and Web browser-based Authoring. Importantly, according to the present invention, all content resides on the server. The system is operable to provide for author user(s) to directly check-out, subscribe to, or otherwise utilize a piece of content, i.e., a discrete content element. By way of contrast to prior art web-based content and learning systems, the system of the present invention further provides for author user(s) to updates, modify, add to, and/or use such content without downloading the content to a local client workstation. This operationally facilitates content authoring, not only by individual author users but also for collaborative projects involving more than one author user. The browser-based access to content facilitates searching for specific content modules and combining, editing, and recombining them to create new content, essentially streamlining the evolution of content both individually and collaboratively across every substantive content area possible.

Content Reuse. The systems and methods of the present invention further provide for content objects and content bits to be reused and recombined by author users. Because the format-neutral content is created, developed, stored and managed by subcomponents, i.e., the lowest level of freestanding or independent content elements, the system facilitates the author user's ability to share and reuse content objects, including the ability to manage all content as a unique item, meta-data tag to search and use it, and to track all the links where the content is used. This is particularly significant for management and enforcement of digital content rights for authors.

Collaborative Authoring Content Commercialization, and Digital Rights Management. As set forth hereinabove, the system and methods of the present invention are operable for collaborative authoring of content wherein a multiplicity of authors or author users many work on different content items and/or objects that can be reused and assembled or recombined to form new composite content for presentation to users in a multiplicity of formats at the time of presentation or content access by the user. Author users can share any level of content element—from the most primary content element to composite content—with other authors while ensuring attribution of the content to the appropriate author through the automatic content source tracking of the systems and methods of the present invention. The content is tracked automatically and attributed content componentially to each respective author so that content ownership, use, and royalty payments, as well as approvals of use are managed by the system since content authoring, use/reuse, and presentation or user content access is completely integrated on the web-based platform. By way of example, an author user can share a single page of content, another author can access it, share it, modify it, etc.

By automatically managing digital rights at the most elemental content level from authoring to user access (including other author users as well as end users), electronic commerce related to content use payments is enabled by the present invention. The system provides for royalty payments and/or content purchase by users based upon access, type of use, group use, and other factors. Payment management, including pricing and discounting factors, are provided by the present invention as well. Rewards, payment, free content access and the like can be provided, tracked, and managed by the system; new compensation or commerce for content are enabled and operational with the system, for example, recommenders can receive rewards or compensation for inviting other users or sharing content with other users wherein the referred users access the same content within predetermined time periods, or according to other rules or guidelines. Author users can define their own compensation preferences. Alternatively or additionally, end users can define content value based upon references, access history, and the like. Groups can negotiate content discounts or define their own payment restrictions so that only content that matches their requirements is accessible by the group member users within those group access privileges. In another form of electronic commerce, links to advertisements may be made available at the page level of a user interface at the end user during content access; these links can be associated with, related to, or relevant to the content being accessed or to the user profile.

User Notes and Sharing. Since authoring is provided for content elements, end users have the option of creating their own content in the form of end user notes, annotation or comments at predetermined levels. Preferably, the system provides an option for the end user to selectively activate during content access on the user interface so that the end comments are entered at each page level in a window next to the content view; these notes may be shared by the user so that any user or predetermined users reviewing the same content have access to consider or review the first user notes in addition to the content being accessed. The system also provides an option for the end user to insert links, such as to other related web sites or knowledge resources or experts within the system.

Content Download. In addition to online browsing provided by the system, a user has the option to download content. The content download is operable to a variety of remote access devices, such as download to the PC/Laptop (like an eBook or multimedia presentation), download content to a PDA, and the like. Additionally, since the content is provided as content elements that are format-neutral at the authoring side, content download is optionally provided for the user to select download in formats other than what was viewed at the content access moment. Content progress/usage is preferably recorded locally on the disc and then uploaded to the server when the user and that remote access device are reconnected in electronic communication therewith.

Content Workflows. The system and methods of the present invention are operable to track and manage the different stages of content development—from authoring or initial creation of format-neutral content through publishing or presentation to the end user being trained by content access to the system. The content workflows further include tracking and management for state changes for the content, i.e., format and recombination, in particular. Reviewers can add comments by date at a page level and the system may be configured to allow multiple reviewers in serial or parallel process and multiple iterations. The Workflows may be modified at any time and are managed independent of the content.

User Profiles. The system provides for user profiles that are associated with a given user. The user profile preferably includes: location, language, department, job role, desired skills or gaps in skill, and the like, and combinations thereof. The system is operable to dynamically detect the user profile and its profile attributes and to adjust the content and format of content presentation, including multimedia options as well as sequence of presentation, to personalize the content for a given user based on these profile attributes. For example, a user with higher bandwidth for content or data access from their respective remote access device may see a video stream on a web page while a user with lower bandwidth and/or a different remote access device may be shown a static image or a series of static images with text instead of video, thereby optimizing presentation based upon the user profile, which includes factors like bandwidth, remote access device type, etc.

In addition to providing pre-created programs, the system is operable to provide user-defined programs, wherein end-users have the option to create their own programs by selecting different components (from drop down or click-select options on a user interface of the system) that include different delivery modalities such as online multimedia and face-to-face meetings.

Certain modifications and improvements will occur to those skilled in the art upon a reading of the foregoing description. By way of example, components within the system and methods of the present invention as set forth hereinabove may be considered individually or separately from the system, such as, by way of example and not limitation, modularized content, i.e., the content and its development being separate from the format in which a user views it; the sequencing rules for providing modules of content in more than one order to personalize it to different users; the personalization rules; the rendering logic that provides for content neutral format options; etc. Also, the systems and methods of the present invention provide for blending programs, i.e., combining content objects and LTs with Collaborative Events, Discussions, Wikis, eMail and the like. The system for providing an integrated, interactive web-based content access platform for training according to the present invention may further provide for peer networks wherein users may search for and identify others with like minded interests or find mentors. Also, the system is operable to provide methods for user recommendations on knowledge content resources and sequence in which they should access the content in order to gain mastery. Content such as documents exchange, links to external web references or discussion with a mentor or peers may occur within a program. In addition, timers and other conditional rules may be easily added through non programmatic way to allow any user to alter the flow or sequence of the interactions within the program.

Integrated Knowledge On-Demand Platform

Integration of Learning Management, Knowledge Management, Web Collaboration, Online Community and Job-Performance Management modules provides a unique synthesis of different communication methods in which different type of content may be presented or delivered to the users and connections to peers and experts can meaningfully be orchestrated through automated and non-automated ways. These applications have existed as independent silos in the past, the innovation of the system includes the ability for the organizations to select different application components through a non-programmatic interface to set up the Knowledge On-Demand web portal environment. The system handles the complexity of interconnecting content creation, delivery, tracking, reporting and matching the programs with the end-user and job context.

Knowledge Network—linking Knowledge-Content Publishers or suppliers and Knowledge Experts with Learners or Knowledge seekers globally.

The system enables multiple suppliers of education and training content to create their own sub-portal and publish their own content into that sub-system. The end-users may search for content by categories, user defined tags, and skill areas across all the sub-portals and purchase and subscribe to the content in a uniform manner. The system provides an automated mechanism to link training and online knowledge-content suppliers with knowledge-content seekers. Each end-user can select their own preferences and based on those preferences and past training history they are presented with options to be connected with experts and peers. Further, the links to the content resources can be pushed to the end-user and upon authenticating the user the linked content is presented to the user.

The above mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the claimed invention.

What is claimed is:

1. A system for integrated web-based interactive training content development, management and distribution comprising:
a network for remote access by users to a content distribution server having privilege-based user access to content in at least one delivery format, wherein the content is stored on a content server in a format-neutral manner that is deliverable to the users via the network in dynamically recombinable formats based upon user profiles.

2. The system of claim 1, wherein the system provides a prescriptive content and an adaptable content based upon user profiles.

3. The system of claim 1, wherein the prescriptive content and the adaptable content are based upon user profiles and based on performance during content delivery sessions.

4. The system of claim 1, wherein the user profiles are persistently stored on the content distribution server.

5. The system of claim 1, wherein the user profiles are regularly updated.

6. A method for providing web-based interactive training content development, management and distribution comprising the steps of:
providing a system for integrated web-based interactive training content development, management and distribution comprising a network for remote access by users to a content distribution server having privilege-based user access to content in at least one delivery format, wherein the content is stored on a content server in a format-neutral manner that is deliverable to the users via the network in dynamically recombinable formats based upon user profiles;
providing access to the system for registered users based upon user privileges.

7. The method of claim 6, further including the steps of providing format-neutral content and delivering the format-neutral content in a format-specific mode based upon the user profile.

8. The method of claim 6, further including the step of the system updating the user profile based upon user inputs and content transmission performance during content delivery sessions.

9. The method of claim 6, further including the step of persistently storing the user profiles on the content distribution server.
